(19) United States
(12) Patent Application Publication
(10) Pub. No.: US 2022/0171604 A1
(43) Pub. Date: Jun. 2, 2022

(54) Multiplier Circuit Array, MAC and MAC Pipeline including Same, and Methods of Configuring Same

(71) Applicant: Flex Logix Technologies, Inc., Mountain View, CA (US)

(72) Inventors: Frederick A Ware, Los Altos Hills, CA (US); Cheng C. Wang, San Jose, CA (US)

(21) Appl. No.: 17/511,798

(22) Filed: Oct. 27, 2021

Related U.S. Application Data
(60) Provisional application No. 63/120,498, filed on Dec. 2, 2020.

(51) Int. Cl. G06F 7/544; G06F 7/499; G06F 7/487

(52) U.S. Cl. CPC G06F 7/5443; G06F 7/4876; G06F 7/49947

(57) ABSTRACT

An integrated circuit comprising a MAC pipeline including a plurality of MACs connected in series to perform concatenated multiply and accumulate operations, wherein each MAC includes a multiplier circuit array, including a plurality of multiplier circuits, to multiply first data and weight data and generate product data. The plurality of multiplier circuits, in one embodiment, includes a first multiplier circuit to multiply first portions of the first data and the weight data to generate a first field, and a second multiplier circuit to multiply a second portions of the first data and weight data to generate a second field, wherein the product data includes data which is representative of the first field and the second field. An accumulator circuit adds the product data, output from the associated multiplier circuit array, and second data. The multiply cores of the first and second multiplier circuits are separate and different.

### RELATED APPLICATION

This non-provisional application claims priority to and the benefit of U.S. Provisional Application No. 63/120,498, entitled “Multiplier Circuitry having Multiplier Circuit Array, MAC and MAC Pipeline including Same, and Methods of Configuring Same”, filed Dec. 2, 2020. The '498 provisional application is hereby incorporated herein by reference in its entirety.

### INTRODUCTION

There are many inventions described and illustrated herein. The present inventions are neither limited to any single aspect nor embodiment thereof, nor to any combinations and/or permutations of such aspects and/or embodiments. Importantly, each of the aspects of the present inventions, and/or embodiments thereof, may be employed alone or in combination with one or more of the other aspects of the present inventions and/or embodiments thereof. All combinations and permutations thereof are intended to fall within the scope of the present inventions.

In one aspect, the present inventions are directed to an integrated circuit having (i) a multiplier circuit array and/or (ii) one or more multiplier-accumulator circuits, wherein each multiplier-accumulator circuit includes/include a distinct or separate multiplier circuit array to implement or perform multiply operations (e.g., multiply input data and filter weights having a floating point data format). The multiplier circuit array includes a plurality of interconnected multiplier circuits. The multiplier circuits, in one embodiment, are disposed adjacent each other and are interconnected, for example, via a dedicated multi-drop or point-to-point bus. In another embodiment, the multiplier circuit array includes a first multiplier circuit having circuitry including a second multiplier circuit incorporated or embedded therein (e.g., the multiply core of the second multiplier circuit is incorporated or embedded into the circuitry of first multiplier circuit).

In operation, the plurality of interconnected multiplier circuits of the multiplier circuit array perform the multiply operation of the multiplier-accumulator circuit. For example, in one embodiment, a first multiplier circuit of the multiplier circuit array performs a first portion of the multiply operation (e.g., in the context of a floating point data format, values of the sign bit fields and the exponent fields of, for example, the input data and filter weights) and one or more other multiplier circuits of the multiplier circuit array process or perform one or more other portions of the multiply operation (e.g., in the context of a floating point data format, values of fraction fields of, for example, the input data and filter weights—via, for example, two's complement multiplication). Thereafter, the “product” or output of each multiplier circuit may be “combined” or “joined” into data having a particular data format. For example, the output of the first multiplier circuit corresponding to the first portion of the multiply operation (e.g., values of the sign bit fields and the exponent fields of two operands) may be combined or joined with the output of a second multiplier circuit corresponding to a second portion of the multiply operation (e.g., values of fraction fields of the two operands—via, for example, two's complement multiplication) to form or construct a composite product/output having sign, exponent, and fraction fields.

Thus, in one embodiment, the operands are deconstructed into predetermined fields (e.g., sign, exponent and fractions), wherein the related fields of the operands are multiplied by one of the plurality of multiplier circuits. Thereafter, the “product” or output of each multiplier circuit may be “combined” or “joined”—wherein the data from the multiplier circuits are “reconstructed” into product data having a predetermined data format (e.g., programmable format—one-time or more than one-time). The predetermined format of the product data (e.g., (i) floating point or integer type and/or (ii) bit lengths of the fields) may or may not be the same as one or both of the operands.

The plurality of interconnected multiplier circuits of the multiplier circuit array, in one embodiment, may perform the multiply operations based on different data formats (e.g., a first multiplier circuit may be a floating point type and a second multiplier circuit may be an integer type). Moreover, the plurality of interconnected multiplier circuits, in one embodiment, may include the same or different multiplication precisions (e.g., a first multiplier circuit may be an x-bit floating point type (e.g., 32 bit floating point type multiplier circuit) and a second multiplier circuit may be a y-bit integer type (wherein y may or may not equal x; e.g., a 32 bit integer type multiplier circuit, a 24 bit integer type multiplier circuit, or a 16 bit integer type multiplier circuit). Indeed, in one embodiment, the multiplier circuit array may include three or more multiplier circuits wherein each multiplier circuit includes a different multiplication precision (e.g., a first multiplier circuit may be an x-bit floating point type (e.g., 32 bit floating point type multiplier circuit), a second multiplier circuit may be a y-bit integer type (e.g., a 16 or 24 bit integer type multiplier circuit), and a third multiplier circuit may be a z-bit integer type (e.g., an 8 bit integer type multiplier circuit).

Notably, each multiplier circuit of the multiplier circuit array may be a complete and fully functional/capable multiplier circuit or may be a partial multiplier circuit including only certain or selected circuitry of a complete and fully functional/capable multiplier circuit (e.g., omission of: (i) circuitry to perform the multiply operation corresponding to sign fields of the operands, and/or (ii) circuitry to perform the multiply operation corresponding to the exponent fields of the operands and/or (iii) circuitry to perform the multiply operation corresponding to the fraction fields of the operands). For example, in one embodiment, a first multiplier circuit may be an x-bit floating point type (e.g., a 32 bit or 24 bit floating point type multiplier circuit) which processes or performs a first portion of the multiply operation (e.g., values of the sign bit fields and the exponent fields of, for example, the input data and filter weights) and a second multiplier circuit may be a y-bit integer type (e.g., a 32 bit, 24 bit or 16 bit integer type multiplier circuit) which processes or performs one or more other portions of the multiply operation (e.g., values of fraction fields of, for example, the input data and filter weights). In this exemplary embodiment, the first multiplier circuit may not include circuitry to perform the one or more portions of the multiply operation that is to be performed by the second multiplier circuit (e.g., circuitry associated with the multiply operation of the values of fraction fields of, for example, the input data and filter weights). Similarly, the second multiplier circuit may not include circuitry to perform the one or more portions of the multiply operation that is to be performed by the first multiplier circuit (e.g., circuitry associated with the multiply operation corresponding to the values of the sign bit fields and the exponent fields of, for example, the input data and filter weights).

The multiplier circuits of the multiplier circuit array may be interconnected via conductors (e.g., one or more buses (e.g., point-to-point and/or multi-drop)). For example, in one embodiment, at least one of the multiplier circuits of the multiply circuit array outputs data of the product resulting from the multiply operation (e.g., the output of the multiply operation of the values of fraction fields of, for example, the input data and filter weights) to another multiplier circuit of the multiply circuit array. Notably, in one embodiment, the conductors may also communicate control (e.g., rounding information/data, outputs from fraction detection logic to detect, for example, special values/operands such as ZRO (zero), NAN (not a number), EOVFL (exponent overflow), EUNFL (exponent underflow) and/or INF (infinity)).

One or more (or all) of the multiplier circuits of the multiplier circuit array may also include rounding circuitry to round the resultant product of the multiply operation to generate or provide a predetermined bit length, size or precision of the fraction field of the output data. For example, where the output data includes a floating point data format having a bit length, size or precision of 32 bits, the multiply operation of the two operands may generate more bits corresponding to the fraction field and suitable or defined for 32 bit floating point data. Here, the rounding circuitry generates or provides rounding data which is employed to round the fraction field of the operand of the product to an appropriate bit length, size or precision corresponding to the data format (e.g., in the context of a 32 bit floating point data format, a 23 bit fraction field). Thus, in one embodiment, the rounding circuitry generates data/information to round the resultant product of the fraction fields of the operands.

In addition, in one embodiment, at least one of the multiplier circuits of the multiplier circuit array, using data generated from the multiply operations in the plurality of multiplier circuits, may include circuitry to generate, form or construct the output data having (i) a sign bit of the resultant product, and (ii) a value of an exponent field of the resultant product having a predetermined bit length, size or precision, and (ii) a value of a fraction field of the resultant product having a predetermined bit length, size or precision. That multiplier circuit may acquire or obtain the data from the other multiplier circuit(s) of the array via interconnect conductors (e.g., one or more buses (e.g., point-to-point and/or multi-drop)). Thereafter, the output data generated by the multiplier circuit array, which is the “final” product value resulting from the multiply operation of the two operands having the predefined or predetermined bit length, size or precision of the data format (i.e., a 32 bit floating point data format having a sign bit, an eight bit exponent field and a 23 bit fraction field), may be output on a bus and available to other circuitry, for example, for additional processing. In one embodiment, the output data is provided to an accumulator circuit of a multiplier-accumulator circuit of, for example, a data processing pipeline. Notably, multiplier-accumulator circuits may be referred to herein, at times, as “MACs” or “MAC circuits”, and singularly/individually as “MAC” or “MAC circuit”.

In another exemplary embodiment, the multiplier circuit array may include three (or more) multiplier circuits including, for example, a first multiplier circuit of an x-bit floating point type (e.g., a 32 bit floating point type multiplier circuit) which processes or performs a first portion of the multiply operation (e.g., values of the sign bit fields and the exponent fields of, for example, the input data and filter weights), a second multiplier circuit of a y-bit integer type (e.g., a 16 bit integer type multiplier circuit) which processes or performs one or more portions of the multiply operation (e.g., multiply operations of each first portion of the fraction fields of, for example, the input data and the fraction field portions of the filter weights) and a third multiplier circuit of a z-bit integer type (e.g., an 8 bit integer type multiplier circuit) which processes or performs one or more other portions of the multiply operation (e.g., multiply operations of each second portion of the fraction fields of, for example, the input data and the fraction field portions of the filter weights). In this embodiment, the second and third multiplier circuits may both perform multiply operations of different portions of fraction fields of the operands (e.g., the fractional field portion of the input data and the filter weights). For example, the second multiplier circuit may multiply the most significant bits (MSBs) of the fraction fields of the operands and the third multiplier circuit may multiply the remaining bits (in this example, least signification bits (LSBs)) of the fraction fields of the operands (e.g., the second multiplier circuit may perform or implement the multiply operation with respect to the 16 MSBs and the second multiplier circuit may perform or implement the multiply operation with respect to the 8 LSBs).

In another embodiment, the multiplier circuit array may include three (or more) multiplier circuits—wherein only two of the multiplier circuits are employed in the multiplication operation. For example, a first multiplier circuit of an x-bit floating point type (e.g., a 32 bit floating point type multiplier circuit) which processes or performs a first portion of the multiply operation (e.g., values of the sign bit fields and the exponent fields of, for example, the input data and filter weights), a second multiplier circuit of a y-bit integer type (e.g., an 8 bit integer type multiplier circuit) which may be employed to processes or performs a second portion of the multiply operation (e.g., multiply operations the fraction fields of, for example, the input data and the fraction fields of the filter weights) and a third multiplier circuit of a z-bit floating point type (e.g., an 16 bit floating point type multiplier circuit) which processes or performs the first portion or the second portion of the multiply operation (e.g., multiply operations of (i) sign bit fields and the exponent fields of, for example, the input data and filter weights, or (ii) fraction fields of, for example, the input data and the fraction field portions of the filter weights). In this embodiment, the first and second multiplier may be employed to perform the multiply operation, the first and the third multiplier circuits may be employed to perform multiply operations, or the second and third multiplier circuits may be employed to perform multiply operations. Thereafter, the “product” or output of each multiplier circuit may be “combined” or “joined”—wherein the data from the multiplier circuits are “reconstructed” into product data having a predetermined data format. The predetermined format of the product data (e.g., (i) floating point or integer type and/or (ii) bit lengths of the fields) may or may not be the same as one or both of the operands—and which format may be programmable (e.g., one-time or more than one-time).

Each multiplier circuit of the multiplier circuit array may include enable/disable circuitry and/or select/deselect circuitry to facilitate the operable configuration of the multiplier circuit array to implement a predetermined multiply operation (e.g., operations performed having a predetermined data format and using a predetermined precision to, for example, provide output data (resultant product) having a predetermined format and predetermined precision). For example, where one or more of the multiplier circuit(s) of the multiplier circuit array is/are employed or incorporated in the multiply operations, such multiplier circuit(s) is/are enable and configured to process or perform a portion of the multiply operation (e.g., values of the sign bit fields and the exponent fields of, for example, the input data and filter weights) and one or more other multiplier circuit(s) of the multiplier circuit array perform one or more other portions of the multiply operation (e.g., values of fraction fields of, for example, the input data and filter weights). In the event that one or more of the multiplier circuit(s) of the array is/are not employed or utilized in performance of the multiply operations, such one or more of the multiplier circuit(s) is/are deselected and, in one embodiment, disabled (e.g., de-coupled from the input and output bus, de-coupled from the interconnection bus and/or electrically powered-down).

The configuration of the multiplier circuit array may be user or system defined and/or may be one-time programmable/configurable (e.g., at manufacture) or more than one-time programmable/configurable (e.g., (i) at or via power-up, start-up or performance/completion of the initialization sequence/process sequence, and/or (ii) in situ (i.e., during operation of the integrated circuit), at manufacture, and/or at or during power-up, start-up, initialization, re-initialization, configuration, re-configuration or the like). In one embodiment, control circuitry is employed to program/configure the multiplier circuit array including the plurality of multiplier circuits. The control circuitry, in one embodiment, programs/configures the multiplier circuit array one-time; in another embodiment, the control circuitry programs/configures the multiplier circuit array more than one-time (i.e., multiple times). For example, the control circuity may receive select and/or enable signals from internal or external circuitry (i.e., external to the one or more integrated circuits—for example, a host computer/processor) including one or more data storage circuits (e.g., one or more memory cells, register, flip-flop, latch, block/array of memory), one or more input pins/conductors, a look-up table LUT (of any kind), a processor or controller and/or discrete control logic. The control circuitry, in response thereto, may employ such signal(s) to enable or disable selected multiplier circuits of the multiplier circuit array and thereby configure the multiplier circuitry of, for example, the MAC or MACs of a data processing pipeline, to implement the multiply operations. The control circuitry may configure the multiplier circuitry in situ and/or at or during power-up, start-up, initialization, re-initialization, configuration, re-configuration or the like. Indeed, in one embodiment, control circuitry may evaluate the input data and, based thereon, implement or select a configuration of the multiplier circuit array to provide the appropriate configuration to implement or provide a predetermined precision and data format of the resultant multiplication product (output data).

For example, the multiplier circuit array may include, a first multiplier circuit of an x-bit floating point type (e.g., a 32 bit floating point type multiplier circuit), which processes a first portion of the multiply operation (e.g., values of the sign bit fields and the exponent fields of, for example, the input data and filter weights), a second multiplier circuit of a y-bit integer type (e.g., a 24 bit integer type multiplier circuit), which processes one or more portions of the multiply operation (e.g., values of fraction fields of, for example, the input data and filter weights) and a third multiplier circuit may be a y-bit integer type (e.g., an 8 bit integer type multiplier circuit) which processes one or more portions of the multiply operation (e.g., values of fraction fields of, for example, the input data and filter weights). Where the precision and data format of the input data and filter weights are 16 bit floating point data format, control circuitry may enable and select the first multiplier circuit and one of the second or third multiplier circuits of the multiplier circuit array to implement the multiply operations of the multiplier circuitry. Here, the control circuitry may configure the multiplier circuit array so that the first multiplier circuit performs or implements the multiply operation in connection with the values of the sign bit fields and the exponent fields of, for example, the input data and filter weights, and the second multiplier circuit or the third multiplier circuit of the multiplier circuit array performs or implements the multiply operation in connection with the values of fraction fields of the input data and filter weights (in this example, a 8×8 multiply operation).

In another embodiment, where the precision and data format of the input data and filter weights have a 24 bit floating point data format, control circuitry may enable and select the first and second multiplier circuits of the multiplier circuit array to implement the multiply operations of the multiplier circuitry. Here, the first multiplier circuit may perform or implement the multiply operation in connection with the values of the sign bit fields and the exponent fields of, for example, the input data and filter weights, and the second multiplier circuit of the multiplier circuit array may perform or implement the multiply operation in connection with the values of fraction fields of the input data and filter weights (in this example, a 16×16 multiply operation). Notably, the third multiplier circuit (in this exemplary embodiment, an 8 bit integer type multiplier circuit), does not have the capacity to efficiently multiply the 15 bit values of each fraction field of the input data and filter weights. Thus, the control circuitry enables and selects the first and second multiplier circuits of the multiplier circuit array which communicate via the interconnect conductors disposed therebetween.

In another embodiment, where the precision and data format of the input data and filter weights have a 16 bit floating point data format, control circuitry may enable and select the first and third multiplier circuits of the multiplier circuit array to implement the multiply operations of the multiplier circuitry. Here, the first multiplier circuit may perform or implement the multiply operation in connection with the values of the sign bit fields and the exponent fields of, for example, the input data and filter weights, and the third multiplier circuit of the multiplier circuit array may perform or implement the multiply operation in connection with the values of fraction fields of the input data and filter weights (in this example, a 8×8 multiply operation). Notably, the third multiplier circuit (in this exemplary embodiment, an 8 bit integer type multiplier circuit), includes the capacity to efficiently multiply the 7 bit values of each fraction field of the input data and filter weights. Alternatively, the second multiplier circuit of the multiplier circuit array may perform or implement the multiply operation in connection with the values of fraction fields of the input data and filter weights (in this example, a 16×16 multiply operation)—however, it may be more efficient (power and timing) to employ the 8 bit integer type multiplier circuit given the difference in bit size of the multiply core (8 bit vs. 16 bit) circuit. Thus, the control circuitry enables and selects the first and third multiplier circuits of the multiplier circuit array which communicate via the interconnect conductors disposed therebetween.

In yet another embodiment, where the precision and data format of the input data and filter weights are 32 bit floating point, control circuitry may enable and select the first, second and third multiplier circuits of the multiplier circuit array to implement the multiply operations of the multiplier circuitry. Here, the first multiplier circuit may perform or implement the multiply operation in connection with the values of the sign bit fields and the exponent fields of, for example, the input data and filter weights, and the second multiplier circuit of the multiplier circuit array may perform or implement the multiply operation in connection with the values of a first portion of the fraction fields of the input data and filter weights, and the third multiplier circuit of the multiplier circuit array may perform or implement the multiply operation in connection with the values of a second portion of the fraction fields of the input data and filter weights.

As discussed above, the multiplier circuits of the multiplier circuit array may be programmed/configured via control circuitry, for example, in situ (i.e., during operation of the integrated circuit), at manufacture, and/or at or during power-up, start-up, initialization, re-initialization, configuration, re-configuration or the like.

Notably, the multiplier circuit array of the present inventions may be incorporated and/or implemented in one or more (or all) multiplier-accumulator circuits of an execution or processing pipeline including execution circuitry employing one or more floating point data formats. Here, in another aspect of the present inventions, the multiplier-accumulator circuit(s) may include a multiplier circuit array (which, in one embodiment, is configurable to provide a predetermined precision of the resultant multiplication product (output data)). The multiplier circuit array may include a floating point type multiplier and an integer type multiplier. The output of the multiplier circuit array, having a floating point data format, may be provided to the accumulator circuit, which is a floating point type accumulator. In one embodiment, the execution or processing pipeline includes a plurality of multiplier-accumulator circuits, each circuit including a multiplier circuit array (e.g., having an identical configuration). For example, the plurality of multiplier-accumulator circuits (each having multiplier circuit array) may be interconnected (in series) to perform the multiply and accumulate operations and/or the pipelining architecture or configuration implemented via connection of multiplier-accumulator circuits. In this pipeline architecture, for example, the plurality of multiplier-accumulator circuits may concatenate the multiply and accumulate operations of the data processing.

The multiplier circuit array of the present inventions may be employed and/or implemented in the circuitry described and/or illustrated in U.S. patent application Ser. Nos. 16/545,345, 17/019,212 and/or 17/391,082. Here, the multiplier circuit array of the present inventions may be incorporated into the multiplier circuitry of the multiplier-accumulator circuit described and/or illustrated in the '345, '212 and/or '082 applications to, for example, facilitate concatenating the multiply and accumulate operations, and reconfiguring the circuitry thereof and operations performed thereby (see, e.g., the exemplary embodiments illustrated in FIGS. 1A-1C of U.S. patent application Ser. No. 16/545,345). In this way, each multiplier-accumulator circuit includes a multiplier circuit array to, for example, process data (e.g., image data) in a manner whereby the processing and operations are performed as described herein. The '345, '212 and '082 applications are incorporated by reference herein in their entirety.

The multiplier circuit array of the present inventions may also be employed and/or implemented in the multiplier-accumulator circuits of the processing pipelines or architectures, and circuitry to configure and control such pipelines/architectures, described and/or illustrated in U.S. patent application Ser. Nos. 17/019,212 and 17/391,082. In this regard, the multiplier circuitry of the multiplier-accumulator circuits may include the multiplier circuit array described and illustrated herein; as noted above, the '212 and '082 applications are incorporated by reference in their entirety.

Further, the multiplier-accumulator circuits (having the multiplier circuit array of the present inventions described and/or illustrated herein) may be interconnected into execution or processing pipelines as described and/or illustrated in U.S. patent application Ser. No. 17/212,411; the '411 application is incorporated by reference herein in its entirety. In one embodiment, the circuitry configures and controls a plurality of separate multiplier-accumulator circuits (each having a multiplier circuit array of the present inventions) or rows/banks of such multiplier-accumulator circuits (which are interconnected, for example, in series (such rows/banks thereof are referred to, at times, as clusters) to pipeline multiply and accumulate operations. In one embodiment, the plurality of multiplier-accumulator circuits (having the multiplier circuit array) may include a plurality of registers (including a plurality of shadow registers) wherein the circuitry also controls such registers to implement or facilitate the pipelining of the multiply and accumulate operations performed by the multiplier-accumulator circuits to increase throughput of the multiplier-accumulator execution or processing pipelines in connection with processing the related data (e.g., image data). (See, e.g., '345 application).

In another embodiment, the interconnection of the pipeline or pipelines (each including a plurality of multiplier-accumulator circuits (having the multiplier circuit array of the present inventions described and/or illustrated herein) may be configurable or programmable to provide different forms of pipelining, as described and/or illustrated in U.S. patent application Ser. No. 17/212,411). Here, the pipelining architecture provided by the interconnection of the plurality of multiplier-accumulator circuits (having the multiplier circuit array of the present inventions described and/or illustrated herein) may be controllable or programmable. In this way, a plurality of multiplier-accumulator circuits, each circuit having a multiplier circuit array of the present inventions described and/or illustrated herein, may be configured and/or re-configured to form or provide the desired processing pipeline(s) to process data (e.g., image data). For example, with reference to the '411 application, in one embodiment, control/configure circuitry may configure or determine the multiplier-accumulator circuits having multiplier circuit array described herein, or rows/banks of interconnected multiplier-accumulator circuits having a multiplier circuit array described herein are interconnected (in series) to perform the multiply and accumulate operations and/or the pipelining architecture or configuration implemented via connection of multiplier-accumulator circuits (or rows/banks of interconnected multiplier-accumulator circuits). Thus, in one embodiment, the control/configure circuitry configures or implements an architecture of the execution or processing pipeline by controlling or providing connection(s) between such multiplier-accumulator circuits and/or such rows of interconnected multiplier-accumulator circuits—each of which include one or more multiplier circuit array embodiments described herein.

Notably, the circuitry of the present inventions may be disposed on or in integrated circuit(s), for example, (i) a processor, controller, state machine, gate array, system-on-chip (“SOC”), programmable gate array (“PGA”) and/or field programmable gate array (“FPGA”), and/or (ii) a processor, controller, state machine and SOC including an embedded FPGA, and/or (iii) an integrated circuit (e.g., processor, controller, state machine and SoC)—including an embedded processor, controller, state machine, and/or PGA. Indeed, the circuitry of the present inventions may be disposed on or in integrated circuit(s) dedicated exclusively to such circuitry.

### BRIEF DESCRIPTION OF THE DRAWINGS

The present inventions may be implemented in connection with embodiments illustrated in the drawings hereof. These drawings show different aspects of the present inventions and, where appropriate, reference numerals, nomenclature, or names illustrating like circuits, architectures, structures, components, materials and/or elements in different figures are labeled similarly. It is understood that various combinations of the structures, components, materials and/or elements, other than those specifically shown, are contemplated and are within the scope of the present inventions.

Moreover, there are many inventions described and illustrated herein. The present inventions are neither limited to any single aspect nor embodiment thereof, nor to any combinations and/or permutations of such aspects and/or embodiments. Moreover, each of the aspects of the present inventions, and/or embodiments thereof, may be employed alone or in combination with one or more of the other aspects of the present inventions and/or embodiments thereof. For the sake of brevity, certain permutations and combinations are not discussed and/or illustrated separately herein. Notably, an embodiment or implementation described herein as “exemplary” is not to be construed as preferred or advantageous, for example, over other embodiments or implementations; rather, it is intended reflect or indicate the embodiment(s) is/are “example” embodiment(s).

Notably, the configurations, block/data width, data path width, bandwidths, data lengths, values, processes, pseudo-code, operations, and/or algorithms described herein and/or illustrated in the FIGURES, and text associated therewith, are exemplary. Indeed, the inventions are not limited to any particular or exemplary circuit, logical, block, functional and/or physical diagrams, number of multiplier-accumulator circuits employed in an execution pipeline, number of execution pipelines employed in a particular processing configuration, organization/allocation of memory, block/data width, data path width, bandwidths, values, processes, pseudo-code, operations, and/or algorithms illustrated and/or described in accordance with, for example, the exemplary circuit, logical, block, functional and/or physical diagrams.

Moreover, although the illustrative/exemplary embodiments include a plurality of memories (e.g., L3 memory, L2 memory, L1 memory, L0 memory) which are assigned, allocated and/or used to store certain data and/or in certain organizations, one or more of memories may be added, and/or one or more memories may be omitted and/or combined/consolidated—for example, the L3 memory or L2 memory, and/or the organizations may be changed, supplemented and/or modified. The inventions are not limited to the illustrative/exemplary embodiments of the memory organization and/or allocation set forth in the application. Again, the inventions are not limited to the illustrative/exemplary embodiments set forth herein.

FIGS. 1A, 1B, 1C and 1D illustrate schematic block diagrams of exemplary embodiments of a multiplier circuit array, according to one or more aspects of the present inventions, wherein, in these exemplary embodiments, the multiplier circuit array includes two multiplier circuits connected via an interconnection bus (IB) which, in this exemplary illustrated embodiment, is a dedicated point-to-point and/or multi-drop bus; the interconnection bus (IB) may be a unidirectional bus (FIGS. 1A and 1C) or a bidirectional bus (FIGS. 1B and 1D); input data are provided to the multiplier circuits of the multiplier circuit array via input bus 1 and input bus 2 wherein a first operand (e.g., image data) is provided to the multiplier circuits of the multiplier circuit array via input bus 1 and a second operand (e.g., filter weights) is provided to the multiplier circuits via input bus 2; in one embodiment, the input data 1 (first operand, e.g., image data) and input data 2 (second operand, e.g., filter weights) are provided to the multiplier circuits of the multiplier circuit array via a multiplexed bus (FIGS. 1C and 1D);

FIGS. 2A and 2B illustrate schematic block diagrams of exemplary embodiments of a multiplier circuit array, according to one or more aspects of the present inventions, wherein, in these exemplary embodiments, the multiplier circuit array includes more than two multiplier circuits connected via one or more interconnection buses (IB) which, in this exemplary embodiment, may be dedicated point-to-point buses or a multi-drop bus (not illustrated) that interconnects a plurality of multiplier circuits to one or more other multiplier circuits; the interconnection bus (IB) may be a unidirectional bus (FIG. 2A) or a bidirectional bus (FIG. 2B); input data are provided to the multiplier circuits via input bus 1 and input bus 2 wherein a first operand (input data such as image data) is provided to the multiplier circuits of the multiplier circuit array via input bus 1 and a second operand (e.g., filter weights) is provided to the multiplier circuits via input bus 2; in one embodiment, although not illustrated, the input data 1 (first operand, e.g., image data) and input data 2 (second operand, e.g., filter weights) are provided to the multiplier circuits of the multiplier circuit array via a multiplexed bus (see, however, FIGS. 1C and 1D);

FIGS. 3A-3D illustrate schematic block diagrams of exemplary embodiments of a multiplier circuit array, according to one or more aspects of the present inventions, wherein, in these exemplary embodiments, the multiplier circuit array includes at least two multiplier circuits wherein at least one of the multiplier circuits is embedded or incorporated into the circuitry of another multiplier circuit of the multiplier circuit array (e.g., FIGS. 3A and 3D wherein the multiply core of the multiplier circuit B (e.g., circuitry to perform, two's complement multiplication) is incorporated or embedded into the circuitry of multiplier circuit A); input data are provided to the multiplier circuits via input bus 1 and input bus 2; in one embodiment, a first operand (input data such as image data) is provided to the multiplier circuits of the multiplier circuit array via input bus 1 and a second operand (e.g., filter weights) is provided to the multiplier circuits via input bus 2; as noted above, in one embodiment, the input data 1 (first operand, e.g., image data) and input data 2 (second operand, e.g., filter weights) are provided to the multiplier circuits of the multiplier circuit array via a multiplexed bus (FIG. 3D);

FIG. 4 illustrates an schematic block diagram of an exemplary embodiment of a multiplier-accumulator circuit (MAC), according to one or more aspects of the present inventions, wherein the multiplier circuitry includes a multiplier circuit array, according to one or more aspects of the present inventions, having two or more multiplier circuits (see, e.g., FIGS. 1A-1D, 2A, 2B and 3A-3D); in this exemplary embodiment, the input data (e.g., image data and filter weights) are provided to the plurality of multiplier circuits via input bus(es) and the output of the multiplier circuitry (i.e., the product of the input data) is provided to accumulator circuit wherein it is added to additional data (accumulation data) and output as output data;

FIG. 5A illustrates a schematic block diagram of a plurality of interconnected multiplier-accumulator circuits, each including at least one multiplier circuit array (according to aspects of the present inventions) to perform/implement the multiply operations and accumulator circuit to perform/implement the accumulate operations (e.g., in a concatenated manner), according to aspects of the present inventions; in the illustrated embodiments, the multiplier-accumulator circuit output/provide a partially completed operation of a successive multiplier-accumulator circuit to process data, in a concatenated manner, wherein the output of a multiplier-accumulator circuit X is configurable to be input into a preceding multiplier-accumulator circuit (e.g., multiplier-accumulator circuit A in this illustrative embodiment); in one embodiment, an input selection circuit (not illustrated) may be controlled to input multiple-accumulation data (rotate Y) or input data (rotate D) from (i) a multiplier-accumulator circuit of multiplier-accumulator circuit X (i.e., the same ring) or (ii) a multiplier-accumulator circuit of another multiplier-accumulator circuit (e.g., a multiplier-accumulator circuit in the same ring or another ring) of the configuration;

FIG. 5B illustrates a schematic block diagram of an exemplary logical overview of an exemplary multiplier-accumulator execution or processing pipeline including a plurality of serially connected multiplier-accumulator circuits (forming a linear pipeline), wherein each multiplier-accumulator circuit includes a multiplier circuit array (“MUL”) to perform/implement the multiply operations and accumulator circuit (“ADD”) to perform/implement the accumulate operations (e.g., in a concatenated manner), according to aspects of the present inventions; in one embodiment, the multiplier circuit array of each MAC perform multiply operations in a floating point format and/or integer format and the accumulator circuit perform accumulation or addition operations in a floating point format, according to one embodiment of the present inventions; in this exemplary embodiment, the multiplier-accumulator circuit may include a plurality of memory banks (e.g., SRAM memory banks) that are dedicated to the multiplier-accumulator circuit to store filter weights used by the multiplier circuitry of the associated multiplier-accumulator circuit; in one illustrative embodiment, the MAC execution or processing pipeline includes 64 multiplier-accumulator circuits (m=64); notably, in the logical overview of a linear pipeline configuration of this exemplary multiplier-accumulator execution or processing pipeline, a plurality of processing (MAC) circuits (“m”) are connected in the execution pipeline and operate concurrently; for example, in one exemplary embodiment where m=64, the multiplier-accumulator processing circuits 64×64 multiply-accumulate operations in each 64 cycle interval; notably, the multiplier-accumulator circuits and circuitry of the present inventions may be interconnected or implemented in one or more multiplier-accumulator execution or processing pipelines including, for example, execution or processing pipelines as described and/or illustrated in U.S. patent application Ser. No. 17/212,411; as mentioned herein, the '411 application is incorporated by reference herein in its entirety;

FIG. 5C is a schematic block diagram of a logical overview of an exemplary multiplier-accumulator execution pipeline connected in a linear pipeline configuration, according to one or more aspects of the present inventions, wherein the multiplier-accumulator processing or execution pipeline (“MAC pipeline”) includes multiplier-accumulator circuits (“MACs”), each MAC having, among other things, a multiplier circuit array to perform multiply operations; the plurality of MACs is illustrated in block diagram form; notably, the multiplier-accumulator circuit includes one or more of the multiplier-accumulator circuits (an exemplary multiplier-accumulator circuit is illustrated in schematic block diagram form in Inset A); in this exemplary embodiment, “m” (e.g., 64 in the illustrative embodiment) multiplier-accumulator circuits are connected in a linear execution pipeline to operate concurrently whereby the processing circuits perform m×m (e.g., 64×64) multiply-accumulate operations in each m (e.g., 64) cycle interval (here, a cycle may be nominally 1 ns); notably, each m (e.g., 64) cycle interval processes a Dd/Yd (depth) column of input and output pixels/data at a particular (i,j) location (the indexes for the width Dw/Yw and height Dh/Yh dimensions of this exemplary embodiment Dw=512, Dh=256, and Dd=128, and the Yw=512, Yh=256, and Yd=64) wherein the m (e.g., 64) cycle execution interval is repeated for each of the Dw*Dh depth columns for this stage; in addition, in one embodiment, the filter weights or weight data are loaded into memory (e.g., L1/L0—such as SRAM memory(ies)) before the multiplier-accumulator circuits, each having a multiplier circuit array to perform multiply operations and accumulator circuit to perform accumulate/add operations, start processing (see, e.g., U.S. patent application Ser. Nos. 16/545,345, 17/019,212 and/or 17/391,082);

FIG. 5D illustrates a schematic block diagram of an exemplary multiplier-accumulator execution or processing pipeline including a plurality of serially connected MACs (e.g., 64; when m=64, see FIG. 5E), wherein each multiplier-accumulator circuit includes a multiplier circuit array (“MUL”) to perform/implement the multiply operations and accumulator circuit (“ADD”) to perform/implement the accumulate operations (e.g., in a concatenated manner), according to aspects of the present inventions; in this embodiment, input data values (“D”) are rotated, transferred or moved, on a cycle-by-cycle basis, from one MAC (e.g., MAC Processor 1) of the linear pipeline to the immediately following MAC (e.g., MAC Processor 2) of the execution pipeline (see, D_i[p]) and employed in the multiply operation of the multiplier circuit array of that next MAC (e.g., MAC Processor 2) of the processing pipeline; moreover the output of the accumulator circuit (“ADD”) of each MAC, in this embodiment, is not rotated, transferred or moved to the immediately following MAC of the linear processing pipeline (compare FIGS. 5B and 5C); in this way, the input data values (“D”) are rotated, transferred or moved (e.g., before, during or at the completion of each execution cycle of the execution sequence (i.e., set of associated execution cycles)) through the plurality of serially connected MACs of the pipeline such that, in operation, after input of the initial data input values into the MACs of the linear pipeline (see “Shift in next D”), each input data value (see “Rotate current D”) that is input into a MAC is output before, during or at the completion of each execution cycle to the immediately following MAC of the linear pipeline and employed in the multiplication operation of the multiplier circuit array (“MUL”) of that immediately following MAC, according to one or more aspects of the present inventions; notably, each MAC includes a multiplier circuit array (“MUL”) to perform/implement the multiply operations and accumulator circuit (“ADD”), to perform/implement the accumulate operations, according to one or more aspects of the present inventions; in this exemplary embodiment, MAC processor may include or read from one or more of memory banks (e.g., two SRAM memory banks) that are dedicated to the MAC to store filter weights used by the multiplier circuit array of the associated MAC (as described and illustrated in U.S. patent application Ser. No. 17/212,411, which is hereby incorporated by reference herein; notably, the individual MACs may, at times, be referred to as MAC processors);

FIG. 5E illustrates a schematic block diagram of a logical overview of an exemplary multiplier-accumulator execution pipeline, connected in a linear pipeline configuration wherein input data values (Dijk) are rotated, transferred or moved, on a cycle-by-cycle basis, from one MAC of the linear pipeline to the immediately following MAC of the pipeline and employed in the multiply operation of the multiplier circuit array of that next MAC of the processing pipeline and wherein the MAC pipeline includes multiplier-accumulator circuits (“MACs”), each MAC having, among other things, a multiplier circuit array to perform multiply operations, according to one or more aspects of the present inventions; in this embodiment, before, during or after each cycle of the set of associated execution cycles, the input data are rotated, transferred or moved from a MAC of the linear pipeline to successive MAC thereof wherein the rotated, transferred or moved input data are input or applied to the multiplier circuit array of associated MAC during or in connection with the multiply operation (by the multiplier circuit array) of that MAC; in this embodiment, the accumulation values generated by the accumulator circuit of each MAC are maintained, stored or held, during each execution cycle of the execution sequence (i.e., set of associated execution cycles), in respective MAC (compare the embodiments of FIGS. 5B and 5C) and used in the accumulation operation of the associated accumulator circuit thereof; that is, the accumulation values employed in subsequent processing (i.e., the accumulation operation) in the associated MAC; in this illustrative embodiment, the plurality of MACs is illustrated in block diagram form; an exemplary MAC is illustrated in schematic block diagram form in Inset A; notably, in this exemplary embodiment, “m” (e.g., 64 in one illustrative embodiment) MACs are connected in a linear execution pipeline to operate concurrently whereby the processing circuits perform m×m (e.g., 64×64) multiply-accumulate operations in each m (e.g., 64) cycle interval (here, a cycle may be, for example, nominally 1 ns); notably, in one exemplary embodiment, each m (e.g., 64) cycle interval processes a Dd/Yd (depth) column of input and output pixels/data at a particular (i,j) location (the indexes for the width Dw/Yw and height Dh/Yh dimensions of this exemplary embodiment—Dw=512, Dh=256, and Dd=128, and the Yw=512, Yh=256, and Yd=64) wherein the m (e.g., 64) cycle execution interval is repeated for each of the Dw*Dh depth columns for this stage; in addition, in one embodiment, the filter weights or weight data are loaded into memory (e.g., L1/L0 SRAM memories) before the multiplier-accumulator circuit starts processing (see, e.g., U.S. patent application Ser. Nos. 16/545,345, 17/019,212 and/or 17/391,082);

FIG. 6A illustrates exemplary floating point data formats having different widths or lengths, including respective ranges, and exemplary integer data formats having different widths or lengths, including respective ranges; the three exemplary floating point data formats and integer data formats in this illustration utilize a signed-magnitude numeric format for the sign field and fraction or mantissa field wherein the fraction or mantissa field includes a most-significant weight of 0.5, and a hidden (implicit) bit and, in this embodiment, a weight of 1.0 is added (i.e. normalized fraction); in connection with the floating point data format, the exponent field is a two's complement numeric format to which, in this embodiment, a bias of 127 may be added; the minimum and maximum exponent values are reserved for special operands (NAN, INF, DNRM, ZERO); notably, the 16 bit floating point (FP) data format illustrated herein may be referred to as a BF16 (Brain Floating Point) data format; notably, the format of the floating point data illustrated herein is merely exemplary and not limiting; other formats may be employed including data having (i) smaller or larger total block/data width(s) or length(s), (ii) smaller or larger block/data width(s) or length(s) of the exponent field, and/or (ii) smaller or larger block/data width(s) or length(s) of the fraction or mantissa field; moreover, the format of the fixed point data illustrated herein is merely exemplary and not limiting; other formats may be employed including data having (i) smaller or larger total block/data width(s) or length(s), (ii) smaller or larger block/data width(s) or length(s) of the fraction field, and/or (ii) different location(s) of the binary point relative to the bits of the integer field or fraction field (which has an impact of the range of the fixed point data);

FIG. 6B illustrates exemplary floating point data formats of different precisions; notable, except for the different mantissa precision widths, the formats are similar to, for example, a standard IEEE 754 32 bit floating point data format;

FIG. 7A illustrates a schematic block diagram of exemplary embodiment of a multiplier circuit array, according to one or more aspects of the present inventions, wherein in this exemplary embodiment the multiplier circuit array includes two multiplier circuits connected via an interconnection bus (IB) which, in this exemplary embodiment, is a dedicated point-to-point bus; the interconnection bus (IB) may be a unidirectional bus, as illustrated, or a bidirectional bus; in this exemplary embodiment, multiplier circuit A performs a multiple operation with respect to the values of the sign bit fields and the exponent fields of operand A and operand B (e.g., image data and filter weights, respectively); multiplier circuit B of the multiplier circuit array performs the multiply operation with respect to the values of fraction fields of operand A and operand B (e.g., image data and filter weights, respectively); moreover, multiplier circuit A is a floating point type multiplier circuit (32 bit) and multiplier circuit B is an integer type multiplier circuit (32 bit); the input data, operand A and operand B (both of which, in this exemplary embodiment, have a floating point data format (32 bit)) are provided to the multiplier circuits via input bus 1 and input bus 2, respectively, wherein, in one embodiment, the first operand (A) may be image data and the second operand (B) may be filter weights; in one exemplary embodiment, the output data (product of first operand (A) and second operand (B)) includes a floating point data format (32 bit) and is output on the output bus via multiplier circuit A; in another exemplary embodiment, the output data (product of first operand (A) and second operand (B)) includes an integer data format (64 bit) and is output on the output bus via multiplier circuit B; notably, in this embodiment, multiplier circuit A may output a sign bit generated via such multiplication as part of the integer data format; in one embodiment, the input data 1 (operand A, e.g., image data) and input data 2 (operand B, e.g., filter weights) may be provided to the multiplier circuits of the multiplier circuit array via a multiplexed bus (see, FIGS. 1C and 1D);

FIG. 7B illustrates a schematic block diagram of exemplary embodiment of a multiplier circuit array, according to one or more aspects of the present inventions, wherein, in this exemplary embodiment, logic circuitry is disposed in multiplier circuit B to determine if the fraction values are a minimum value (e.g., 23 h'000000); whereas in FIG. 7A, such circuitry was disposed in multiplier circuit A; here again, the multiplier circuit array includes an interconnection bus (IB) which, in this exemplary embodiment, is a dedicated point-to-point bus; in this embodiment, the size of the bus is smaller than the interconnection bus (IB) because the “min” logic circuitry, disposed in multiplier circuit B, determines if the fraction values and communications the results to the fraction detection logic in multiplier circuit A; the interconnection bus (IB) may be a unidirectional bus, as illustrated, or a bidirectional bus; in this exemplary embodiment, multiplier circuit A performs a multiple operation with respect to the values of the sign bit fields and the exponent fields of operand A and operand B (e.g., image data and filter weights, respectively); multiplier circuit B of the multiplier circuit array performs the multiply operation with respect to the values of fraction fields of operand A and operand B (e.g., image data and filter weights, respectively); moreover, multiplier circuit A is a floating point type multiplier circuit (32 bit) and multiplier circuit B is an integer type multiplier circuit (32 bit); the input data, operand A and operand B (both of which, in this exemplary embodiment, have a floating point data format (32 bit)) are provided to the multiplier circuits via input bus 1 and input bus 2, respectively; in one exemplary embodiment, the output data (product of first operand (A) and second operand (B)) includes a floating point data format (32 bit) and is output on the output bus via multiplier circuit A; in another exemplary embodiment, the output data (product of first operand (A) and second operand (B)) includes an integer data format (64 bit) and is output on the output bus via multiplier circuit B; notably, in this embodiment, multiplier circuit A may output a sign bit generated via such multiplication as part of the integer data format; in one embodiment, the input data 1 (operand A, e.g., image data) and input data 2 (operand B, e.g., filter weights) may be provided to the multiplier circuits of the multiplier circuit array via a multiplexed bus (see, FIGS. 1C and 1D);

FIG. 7C illustrates a schematic block diagram of exemplary embodiment of a multiplier circuit array, according to one or more aspects of the present inventions, wherein, in this exemplary embodiment, GRS logic circuitry is disposed in multiplier circuit B to assess the data for rounding purposes and, in response, provide information employed to perform round-to-nearest-even product result; whereas in FIG. 7A, such circuitry was disposed in multiplier circuit A; here again, the multiplier circuit array includes an interconnection bus (IB) which, in this exemplary embodiment, is a dedicated point-to-point bus; in this embodiment, the size of the bus is smaller than the interconnection bus (IB) because the GRS logic circuitry, disposed in multiplier circuit B, determines if the rounding data and communications such data to the rounding circuitry in multiplier circuit A; the interconnection bus (IB) may be a unidirectional bus, as illustrated, or a bidirectional bus; in this exemplary embodiment, multiplier circuit A performs a multiple operation with respect to the values of the sign bit fields and the exponent fields of operand A and operand B (e.g., image data and filter weights, respectively); multiplier circuit B of the multiplier circuit array performs the multiply operation with respect to the values of fraction fields of operand A and operand B (e.g., image data and filter weights, respectively); moreover, multiplier circuit A is a floating point type multiplier circuit (32 bit) and multiplier circuit B is an integer type multiplier circuit (32 bit); the input data, operand A and operand B (both of which, in this exemplary embodiment, have a floating point data format (32 bit)) are provided to the multiplier circuits via input bus 1 and input bus 2, respectively; in one exemplary embodiment, the output data (product of first operand (A) and second operand (B)) includes a floating point data format (32 bit) and is output on the output bus via multiplier circuit A; in another exemplary embodiment, the output data (product of first operand (A) and second operand (B)) includes an integer data format (64 bit) and is output on the output bus via multiplier circuit B; notably, in this embodiment, multiplier circuit A may output a sign bit generated via such multiplication as part of the integer data format; in one embodiment, the input data 1 (operand A, e.g., image data) and input data 2 (operand B, e.g., filter weights) may be provided to the multiplier circuits of the multiplier circuit array via a multiplexed bus (see, FIGS. 1C and 1D);

FIG. 8A illustrates a schematic block diagram of exemplary embodiment of a multiplier circuit array, according to one or more aspects of the present inventions, wherein in this exemplary embodiment the multiplier circuit array includes more than two multiplier circuits connected via an interconnection bus (IB) which, in this exemplary embodiment, may be a dedicated point-to-point bus or a multi-drop bus; in this exemplary embodiment, multiplier circuit A is a floating point type multiplier circuit (32 bit) and performs a multiple operation with respect to the values of the sign bit fields and the exponent fields of operand A and operand B (e.g., image data and filter weights, respectively); multiplier circuit B of the multiplier circuit array is an integer type multiplier circuit (16 bit) and is configurable to perform the multiply operation with respect to the values of fraction fields of operand A and operand B (e.g., image data and filter weights, respectively); multiplier circuit C is an integer type multiplier circuit (8 bit) and is also configurable to perform the multiply operation with respect to the values of fraction fields of operand A and operand B (e.g., image data and filter weights, respectively); the input data, operand A and operand B (both of which, in this exemplary embodiment, have a floating point data format (32 bit)) are provided to the multiplier circuits via input bus 1 and input bus 2, respectively, wherein, in one embodiment, the first operand (A) may be image data and the second operand (B) may be filter weights; interconnection bus (IB) selection circuitry (see, FIG. 10) is employed to selectively interconnect multiplier circuit B and/or multiplier circuit C to the interconnection bus (IB) and multiplier circuit A; in one embodiment, interconnection bus (IB) selection circuitry are a plurality of multiplexers; in one exemplary embodiment, the output data (product of first operand (A) and second operand (B)) includes a floating point data format (32 bit) and is output on the output bus via multiplier circuit A; in another exemplary embodiment, the output data (product of first operand (A) and second operand (B)) includes an integer data format (32 bit) and is output on the output bus via multiplier circuit B; in yet another embodiment, the output data (product of first operand (A) and second operand (B)) includes an integer data format (16 bit) and is output on the output bus via multiplier circuit C; notably, in this embodiment, multiplier circuit A may output a sign bit generated via such multiplication as part of the integer data format; in one embodiment, the operand A (e.g., image data) and operand B (e.g., filter weights) may be provided to the multiplier circuits of the multiplier circuit array via a multiplexed bus;

FIG. 8B illustrates a schematic block diagram of exemplary embodiment of a multiplier circuit array, according to one or more aspects of the present inventions, wherein in this exemplary embodiment the multiplier circuit array includes more than two multiplier circuits connected via an interconnection bus (IB) which, in this exemplary embodiment, may be a dedicated point-to-point bus or a multi-drop bus; in this exemplary embodiment, multiplier circuit A is a floating point type multiplier circuit (32 bit) and performs a multiple operation with respect to the values of the sign bit fields and the exponent fields of operand A and operand B (e.g., image data and filter weights, respectively); multiplier circuit B of the multiplier circuit array is an integer type multiplier circuit (24 bit) and is configurable to perform the multiply operation with respect to the values of fraction fields of operand A and operand B (e.g., image data and filter weights, respectively); multiplier circuit C is an integer type multiplier circuit (16 bit) and is also configurable to perform the multiply operation with respect to the values of fraction fields of operand A and operand B (e.g., image data and filter weights, respectively); the input data, operand A and operand B (both of which, in this exemplary embodiment, have a floating point data format (32 bit)) are provided to the multiplier circuits via input bus 1 and input bus 2, respectively, wherein, in one embodiment, the first operand (A) may be image data and the second operand (B) may be filter weights; interconnection bus (IB) selection circuitry (see, FIG. 10) is employed to selectively interconnect multiplier circuit B and/or multiplier circuit C to the interconnection bus (IB) and multiplier circuit A; in one embodiment, interconnection bus (IB) selection circuitry are a plurality of multiplexers; in one exemplary embodiment, the output data (product of first operand (A) and second operand (B)) includes a floating point data format (32 bit) and is output on the output bus via multiplier circuit A; in another exemplary embodiment, the output data (product of first operand (A) and second operand (B)) includes an integer data format (48 bit) and is output on the output bus via multiplier circuit B; in yet another embodiment, the output data (product of first operand (A) and second operand (B)) includes an integer data format (32 bit) and is output on the output bus via multiplier circuit C; notably, in this embodiment, multiplier circuit A may output a sign bit generated via such multiplication as part of the integer data format; in one embodiment, the operand A (e.g., image data) and operand B (e.g., filter weights) may be provided to the multiplier circuits of the multiplier circuit array via a multiplexed bus;

FIG. 8C illustrates a schematic block diagram of exemplary embodiment of a multiplier circuit array, according to one or more aspects of the present inventions, wherein in this exemplary embodiment the multiplier circuit array includes more than two multiplier circuits connected via an interconnection bus (IB) which, in this exemplary embodiment, may be a dedicated point-to-point bus or a multi-drop bus; in this exemplary embodiment, multiplier circuit A is a floating point type multiplier circuit (32 bit) and performs a multiple operation with respect to the values of the sign bit fields and the exponent fields of operand A and operand B (e.g., image data and filter weights, respectively); multiplier circuit B of the multiplier circuit array is an integer type multiplier circuit (24 bit) and is configurable to perform the multiply operation with respect to the values of fraction fields of operand A and operand B (e.g., image data and filter weights, respectively); multiplier circuit C is an integer type multiplier circuit (8 bit) and is also configurable to perform the multiply operation with respect to the values of fraction fields of operand A and operand B (e.g., image data and filter weights, respectively); the input data, operand A and operand B (both of which, in this exemplary embodiment, have a floating point data format (32 bit)) are provided to the multiplier circuits via input bus 1 and input bus 2, respectively, wherein, in one embodiment, the first operand (A) may be image data and the second operand (B) may be filter weights; interconnection bus (IB) selection circuitry (see, FIG. 10) is employed to selectively interconnect multiplier circuit B and/or multiplier circuit C to the interconnection bus (IB) and multiplier circuit A; in one embodiment, interconnection bus (IB) selection circuitry are a plurality of multiplexers; in one exemplary embodiment, the output data (product of first operand (A) and second operand (B)) includes a floating point data format (32 bit) and is output on the output bus via multiplier circuit A; in another exemplary embodiment, the output data (product of first operand (A) and second operand (B)) includes an integer data format (48 bit) and is output on the output bus via multiplier circuit B; in yet another embodiment, the output data (product of first operand (A) and second operand (B)) includes an integer data format (16 bit) and is output on the output bus via multiplier circuit C; notably, in this embodiment, multiplier circuit A may output a sign bit generated via such multiplication as part of the integer data format; in one embodiment, the operand A (e.g., image data) and operand B (e.g., filter weights) may be provided to the multiplier circuits of the multiplier circuit array via a multiplexed bus;

FIG. 8D illustrates a schematic block diagram of exemplary embodiment of a multiplier circuit array, according to one or more aspects of the present inventions, wherein in this exemplary embodiment the multiplier circuit array includes more than two multiplier circuits connected via an interconnection bus (IB) which, in this exemplary embodiment, may be a dedicated point-to-point bus or a multi-drop bus; in this exemplary embodiment, control circuitry may responsively enable or disable selected multiplier circuit(s) of the multiplier circuit array which, for example, are not employed in the multiply operation; the architecture of this exemplary embodiment of a multiplier circuit array is largely identical to the exemplary embodiment of the multiplier circuit array of FIG. 8A and, for the sake of brevity the discussion hereof will not be repeated; notably, the control circuitry to responsively enable and/or disable selected multiplier circuit(s) of the multiplier circuit array may be implemented in any of the embodiments of the application; although control circuitry is illustrated generating an “enable signal” which is applied to the multiplier circuits, the control circuitry may generate an enable and/or disable signal—both of which are intended to fall within the scope of the present inventions; in one embodiment, the operand A (e.g., image data) and operand B (e.g., filter weights) may be provided to the multiplier circuits of the multiplier circuit array via a multiplexed bus;

FIGS. 9A-9C illustrate exemplary block diagrams of exemplary embodiments of rounding circuitry including one or more segments to accommodate rounding of one or more widths or sizes of the fractional field, according to one or more aspects of the present inventions;

FIG. 10 is a block diagram of an exemplary embodiment of interconnection bus (IB) selection circuitry which is configurable to selectively interconnect two or more multiplier circuits of the multiplier circuit array; in one embodiment, interconnection bus (IB) selection circuitry are a plurality of multiplexers;

FIG. 11 illustrates a schematic block diagram of exemplary embodiment of a multiplier circuit array, according to one or more aspects of the present inventions, wherein the multiplier circuit array includes at least two multiplier circuits wherein at least one of the multiplier circuits is embedded or incorporated into the circuitry of another multiplier circuit of the multiplier circuit array (see also, FIG. 3A); in this illustrative embodiment, the multiply core of the multiplier circuit B is incorporated or embedded into the circuitry of multiplier circuit A; in this exemplary embodiment, multiplier circuit A performs a multiple operation with respect to the values of the sign bit fields and the exponent fields of operand A and operand B (e.g., image data and filter weights, respectively); multiplier circuit B of the multiplier circuit array performs the multiply operation with respect to the values of fraction fields of operand A and operand B (e.g., image data and filter weights, respectively); moreover, multiplier circuit A is a floating point type multiplier circuit (32 bit) and multiplier circuit B is an integer type multiplier circuit (32 bit); the input data, operand A and operand B (both of which, in this exemplary embodiment, have a floating point data format (32 bit)) are provided to the multiplier circuits via input bus 1 and input bus 2, respectively, wherein, in one embodiment, the first operand (A) may be image data and the second operand (B) may be filter weights; in one exemplary embodiment, the output data (product of first operand (A) and second operand (B)) includes a floating point data format (32 bit) and is output on the output bus via multiplier circuit A; in another exemplary embodiment, the output data (product of first operand (A) and second operand (B)) includes an integer data format (64 bit) and is output on the output bus via multiplier circuit B; notably, in this embodiment, multiplier circuit A may output a sign bit generated via such multiplication as part of the integer data format; in one embodiment, the operand A (e.g., image data) and operand B (e.g., filter weights) may be provided to the multiplier circuits of the multiplier circuit array via a multiplexed bus (see, e.g., FIG. 3D); and

FIG. 12 illustrates a schematic block diagram of exemplary embodiment of a multiplier circuit array, according to one or more aspects of the present inventions, wherein the multiplier circuit array includes at least three multiplier circuits wherein two of the multiplier circuits is embedded or incorporated into the circuitry of another multiplier circuit of the multiplier circuit array; in this illustrative embodiment, the multiply core of the multiplier circuit B and the multiply core of multiplier circuit C are incorporated or embedded into the circuitry of multiplier circuit A (see also, FIG. 3B); in this exemplary embodiment, multiplier circuit A performs a multiple operation with respect to the values of the sign bit fields and the exponent fields of operand A and operand B (e.g., image data and filter weights, respectively); multiplier circuit B and/or multiplier circuit C of the multiplier circuit array perform(s) the multiply operation with respect to the values of fraction fields of operand A and operand B (e.g., image data and filter weights, respectively); moreover, multiplier circuit A is a floating point type multiplier circuit (32 bit), multiplier circuit B is an integer type multiplier circuit (24 bit) and multiplier circuit C is an integer type multiplier circuit (16 bit); the input data, operand A and operand B (both of which, in this exemplary embodiment, have a floating point data format (32 bit)) are provided to the multiplier circuits via input bus 1 and input bus 2, respectively, wherein, in one embodiment, the first operand (A) may be image data and the second operand (B) may be filter weights; in one exemplary embodiment, the output data (product of first operand (A) and second operand (B)) includes a floating point data format (32 bit) and is output on the output bus via multiplier circuit A; in another exemplary embodiment, the output data (product of first operand (A) and second operand (B)) includes an integer data format (64 bit) and is output on the output bus via multiplier circuit B and/or multiplier circuit C (whichever is applicable); notably, in this embodiment, multiplier circuit A may output a sign bit generated via such multiplication as part of the integer data format; in one embodiment, the operand A (e.g., image data) and operand B (e.g., filter weights) may be provided to the multiplier circuits of the multiplier circuit array via a multiplexed bus (see, e.g., FIG. 3D).

Again, there are many inventions described and illustrated herein. The present inventions are neither limited to any single aspect nor embodiment thereof, nor to any combinations and/or permutations of such aspects and/or embodiments. Each of the aspects of the present inventions, and/or embodiments thereof, may be employed alone or in combination with one or more of the other aspects of the present inventions and/or embodiments thereof. For the sake of brevity, many of those combinations and permutations are not discussed or illustrated separately herein.

### DETAILED DESCRIPTION

In one aspect, the present inventions are directed to one or more integrated circuits having processing circuitry, for example, multiplier-accumulator circuits (and methods of operating such circuits), to process data (e.g., filtering image data) wherein the processing circuitry includes a multiplier circuitry including a multiplier circuit array. The multiplier circuit array includes a plurality of interconnected multiplier circuits to implement or perform multiply operations in connection with data (e.g., multiply input data and filter weights). In one embodiment, the data have a floating point data format (e.g., such as 16, 24 and 32 bits). In addition thereto, or in lieu thereof, in another embodiment, the data may have a fixed point data format (e.g., integer data format having, for example, 16, 24 and 32 bits). The multiplier circuit array may include two multiplier circuits wherein each multiplier circuit includes the same or a different circuit types (e.g., floating point type and/or integer type) and/or the same or a different multiplication precision (e.g., multiplier circuit A may be, for example, a 24 bit or 32 bit; and multiplier circuit B may be, for example, a 16, 24 or 32 bit). Indeed, where the processing circuitry is a plurality of multiplier-accumulator circuits, in one embodiment, each multiplier-accumulator circuit includes a dedicated, separate or distinct multiplier circuit array, wherein each multiplier circuit array includes a plurality of interconnected multiplier circuits, to implement or perform multiply operations of the associated multiplier-accumulator circuit.

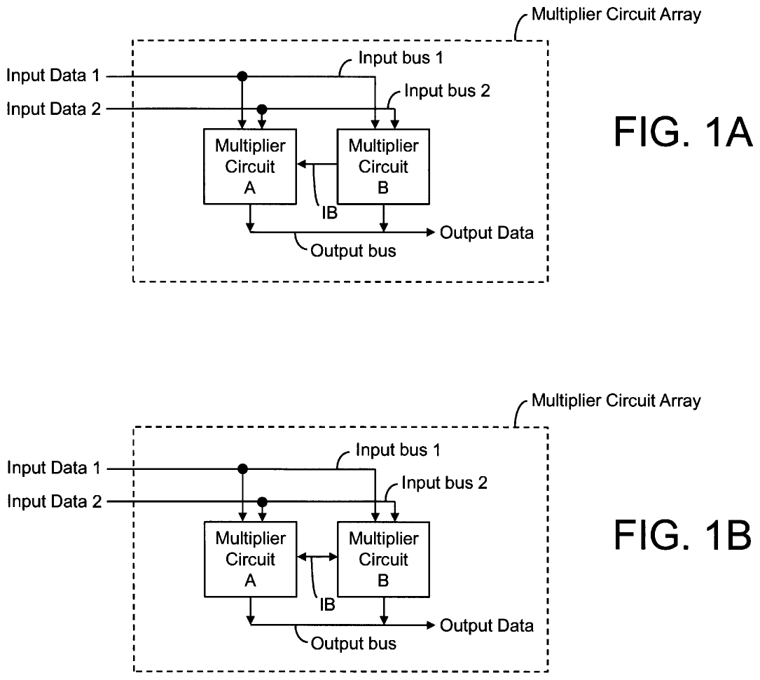

With reference to FIGS. 1A and 1B, the multiplier circuit array of each multiplier-accumulator circuit includes a plurality of interconnected multiplier circuits. The multiplier circuits, in one embodiment, are interconnected via a dedicated point-to-point bus, (interconnection bus (IB)). In one embodiment, in operation, the plurality of interconnected multiplier circuits of the multiplier circuit array perform the multiply operation of the multiplier-accumulator circuit. For example, in one embodiment, a first multiplier circuit of the multiplier circuit array performs a first portion of the multiply operation (e.g., in the context of a floating point data format, the values of the sign bit fields and the exponent fields of, for example, the input data and filter weights) and one or more other multiplier circuits of the multiplier circuit array process or perform one or more other portions of the multiply operation (e.g., values of fraction fields of, for example, the input data and filter weights). (See, FIGS. 1A and 1B).

The plurality of interconnected multiplier circuits of the multiplier circuit array, in one embodiment, may perform the multiply operations based on different data formats (e.g., a first multiplier circuit may be a floating point type and a second multiplier circuit may be an integer type). Moreover, the plurality of interconnected multiplier circuits, in one embodiment, may include the same or different multiplication precisions (e.g., a first multiplier circuit may be an x-bit floating point type (e.g., 32 bit floating point type multiplier circuit) and a second multiplier circuit may be a y-bit integer type (wherein y may or may not equal x; e.g., a 32 bit integer type multiplier circuit, a 24 bit integer type multiplier circuit, or a 16 bit integer type multiplier circuit).

The multiplier circuit array may receive the input data (a first operand, e.g., image data, and a second operand, e.g., filter weights) via a multi-drop bus. (See, FIGS. 1A and 1B). In another embodiment, the multiplier circuit array receives the input data 1 and input data 2 via a multiplexed bus. (See, FIGS. 1C and 1D).

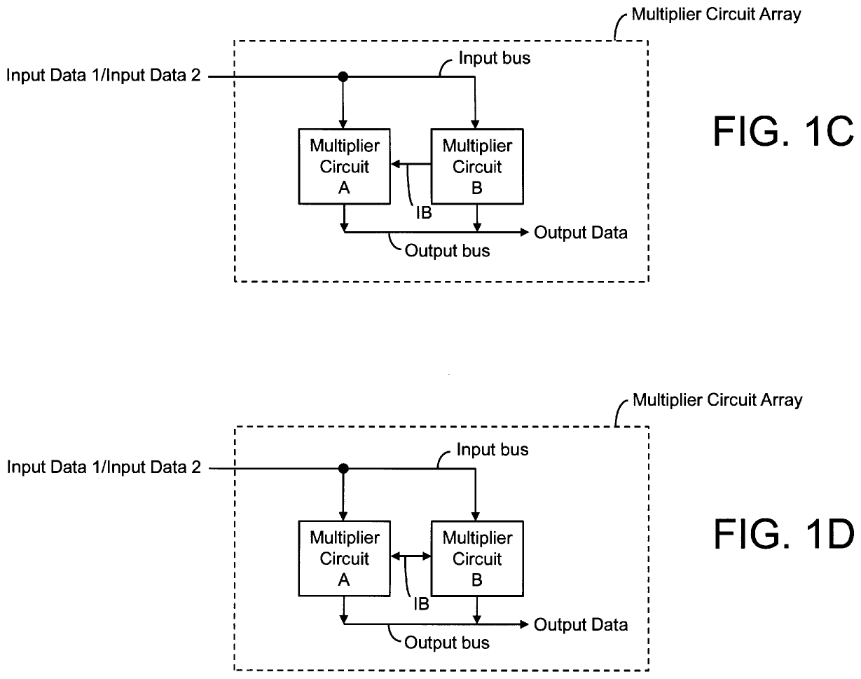

With reference to FIGS. 2A and 2B, in one embodiment, the multiplier circuit array may include three or more multiplier circuits wherein each multiplier circuit includes the same or a different multiplication precision (e.g., multiplier circuit A may be an x-bit floating point type (e.g., 24 bit or 32 bit floating point type multiplier circuit), multiplier circuit B may be a y-bit integer type (e.g., a 16, 24 or 32 bit integer type multiplier circuit), and multiplier circuit C may be a z-bit integer type (e.g., an 8 bit integer type multiplier circuit). That is, the multiplier circuit array may include three or more multiplier circuits wherein a plurality or all of the multiplier circuits includes the same or a different circuit types (e.g., floating point type and/or integer type) and/or the same or a different multiplication precision (e.g., multiplier circuit A may be, for example, a 24 bit or 32 bit; multiplier circuit B may be, for example, a 16, 24 or 32 bit); and multiplier circuit C may be, for example, an 8, 16 or 24 bit).

In one embodiment, two or more of the interconnected multiplier circuits of the multiplier circuit array may perform the multiply operation of the multiplier-accumulator circuit. For example, with reference to FIGS. 2A and 2B, in one embodiment, multiplier circuit A of the multiplier circuit array performs a first portion of the multiply operation (e.g., in the context of a floating point data format, the values of the sign bit fields and the exponent fields of, for example, the input data and filter weights) and multiplier circuit B or multiplier circuit C of the multiplier circuit array may process or perform one or more other portions of the multiply operation (e.g., values of fraction fields of, for example, the input data and filter weights).

The plurality of interconnected multiplier circuits of the multiplier circuit array, in one embodiment, may perform the multiply operations based on same or different data formats wherein the circuitry of the multiplier circuits are the same or different data types. For example, in one embodiment, the multiplier circuit array may multiply two operands each having a floating point data format. In another embodiment, the multiplier circuit array may include two multiplier circuits wherein each multiplier circuit includes different circuit types (e.g., floating point type or integer type). For example, with continued reference to FIGS. 2A and 2B, multiplier circuit A may be a floating point type and multiplier circuit B may be an integer type (wherein the multiply core is an integer type that is configured to perform two's complement multiplication). Indeed, the plurality of interconnected multiplier circuits, in one embodiment, may include the same or different circuit types and multiplication precisions. For example, multiplier circuit A may be an x-bit floating point type (e.g., 24 bit or 32 bit floating point type multiplier circuit), multiplier circuit B may be a y-bit integer type (wherein y may or may not equal x; (e.g., a 32 bit integer type multiplier circuit, a 24 bit integer type multiplier circuit, or a 16 bit integer type multiplier circuit) and multiplier circuit C may be a z-bit integer type (wherein z may or may not equal x and/or y; (e.g., a 8, 16 or 24 bit integer type multiplier circuit).

With continued reference to FIGS. 2A and 2B, in another exemplary embodiment, three (or more) multiplier circuits are employed during operation of the multiplier circuitry including, for example, a first multiplier circuit (e.g., multiplier circuit A) which processes or performs a first portion of the multiply operation (e.g., values of the sign bit fields and the exponent fields of, for example, the input data and filter weights), a second multiplier circuit (e.g., multiplier circuit B) which processes or performs one or more portions of the multiply operation (e.g., multiply operations of each first portion of the fraction fields of, for example, the input data and the fraction field portions of the filter weights) and a third multiplier circuit (e.g., multiplier circuit C) which processes or performs one or more other portions of the multiply operation (e.g., multiply operations of each second portion of the fraction fields of, for example, the input data and the fraction field portions of the filter weights). In this embodiment, the second and third multiplier circuits may both perform multiply operations of different portions of fraction fields of the operands (e.g., the fractional field portion of the input data and the filter weights). For example, the second multiplier circuit may multiply the most significant bits (MSBs) of the fraction fields of the operands and the third multiplier circuit may multiply the remaining bits (in this example, least signification bits (LSBs)) of the fraction fields of the operands (e.g., the second multiplier circuit may perform or implement the multiply operation with respect to the 16 MSBs and the second multiplier circuit may perform or implement the multiply operation with respect to the 8 LSBs).

Notably, each multiplier circuit of the multiplier circuit array may be a complete and fully functional/capable multiplier circuit or may be a partial multiplier circuit including only certain or selected circuitry of a complete and fully functional/capable multiplier circuit (e.g., omission of: (i) circuitry to perform the multiply operation corresponding to sign fields and exponent fields of the operands or (ii) circuitry to perform the multiply operation corresponding to the fraction fields of the operands). For example, in one embodiment, a first multiplier circuit may be an x-bit floating point type (e.g., a 32 bit or 24 bit floating point type multiplier circuit) which processes or performs a first portion of the multiply operation (e.g., values of the sign bit fields and the exponent fields of, for example, the input data and filter weights) and a second multiplier circuit may be a y-bit integer type (e.g., a 32 bit, 24 bit or 16 bit integer type multiplier circuit) which processes or performs one or more other portions of the multiply operation (e.g., values of fraction fields of, for example, the input data and filter weights). In this exemplary embodiment, the first multiplier circuit may not include circuitry to perform the one or more portions of the multiply operation that is to be performed by the second multiplier circuit (e.g., circuitry associated with the multiply operation of the values of fraction fields of, for example, the input data and filter weights). Similarly, the second multiplier circuit may not include circuitry to perform the one or more portions of the multiply operation that is to be performed by the first multiplier circuit (e.g., circuitry associated with the multiply operation corresponding to the values of the sign bit fields and the exponent fields of, for example, the input data and filter weights).

The multiplier circuits of the multiplier circuit array may be interconnected via conductors (e.g., one or more buses (e.g., point-to-point and/or multi-drop)). With reference to FIGS. 1A and 1B, the interconnection bus (IB) may be a point-to-point dedicated bus. Alternatively, reference to FIGS. 2A and 2B, the interconnection bus (IB) may be a multi-drop bus wherein multiplier circuits A, B and C are connected. In one embodiment, at least one of the multiplier circuits of the multiply circuit array outputs data of the product resulting from the multiply operation to another multiplier circuit of the multiply circuit array (e.g., the output of the multiply operation of the values of fraction fields of, for example, the input data and filter weights). Notably, in one embodiment, the conductors may also communicate control or control type data (e.g., rounding information/data, outputs from fraction detection logic to detect, for example, special values/operands such as ZRO (zero), NAN (not a number), EOVFL (exponent overflow), EUNFL (exponent underflow) and/or INF (infinity)).

With reference to FIGS. 1A, 1B, 2A and 2B, in one embodiment, at least one of the multiplier circuits of the multiplier circuit array (e.g., multiplier circuit A), using data generated from the multiply operations in one or more of the other multiplier circuits (e.g., multiplier circuit B), may include circuitry to generate, form or construct the output data (i.e., the product of the two operands) having (i) a sign bit and a value of an exponent field of the resultant product having a predetermined bit length, size or precision, and (ii) a value of a fraction field of the resultant product having a particular data format (e.g., floating point data) and/or predetermined bit length, size or precision. For example, the output of the first multiplier circuit corresponding to the first portion of the multiply operation (e.g., values of the sign bit fields and the exponent fields of two operands) may be “combined” or “joined” with the output of a second multiplier circuit corresponding to a second portion of the multiply operation (e.g., values of fraction fields of the two operands—via, for example, two's complement multiplication) to form or construct a composite product/output having sign, exponent, and fraction fields.

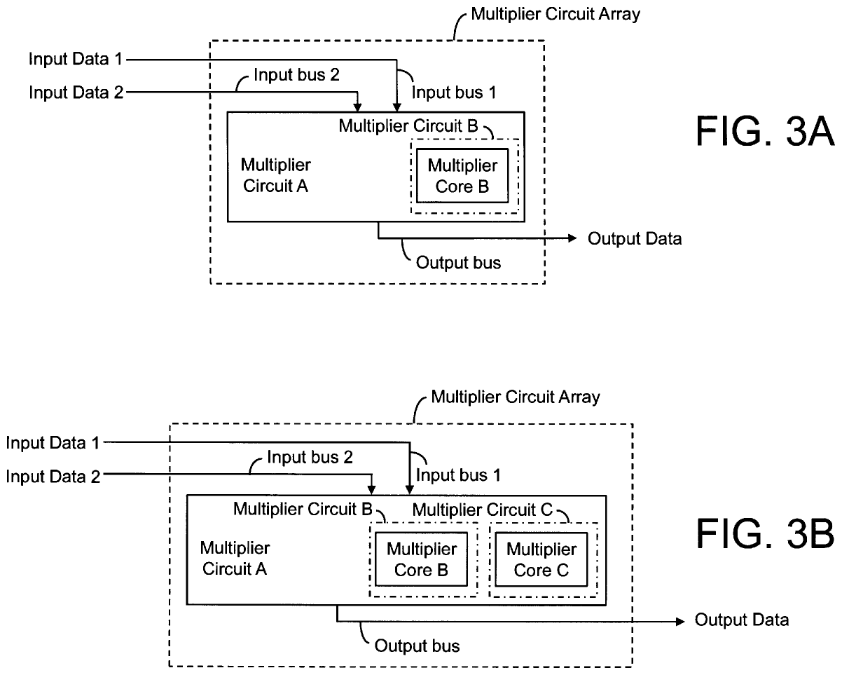

Thus, in one embodiment, the operands are deconstructed into predetermined fields (e.g., sign, exponent and fractions), wherein the related fields of the operands are input to the multiplier circuits and multiplied thereby (e.g., each multiplier circuit performing a portion of the multiply operation). The one multiplier circuit (here, multiplier circuit A) may acquire or obtain the data from the other multiplier circuit(s) of the array (here, multiplier circuit B), via the interconnect conductors/bus (IB) (e.g., one or more buses (e.g., point-to-point and/or multi-drop)). Thereafter, the “product” or output of each multiplier circuit may be “combined” or “joined”—wherein the data from the multiplier circuits are “reconstructed” into product data having a predetermined data format (e.g., programmable format—one-time or more than one-time). That is, the output data generated by the multiplier circuit array, which is the “final” product value resulting from the multiply operation of the two operands having the predefined or predetermined bit length, size or precision of the data format (i.e., a 32 bit floating point data format having a sign bit, an eight bit exponent field and a 23 bit fraction field), may be output by multiplier circuit A on an output bus and thereafter available to other circuitry, for example, for additional processing. The predetermined format of the product data (e.g., (i) floating point or integer type and/or (ii) bit lengths of the fields) may or may not be the same as one or both of the operands. Indeed, in one embodiment, the data output by the multiplier circuit array is provided to the accumulator circuit of the associated MAC of, for example, a data processing pipeline. (See, e.g., FIG. 4).

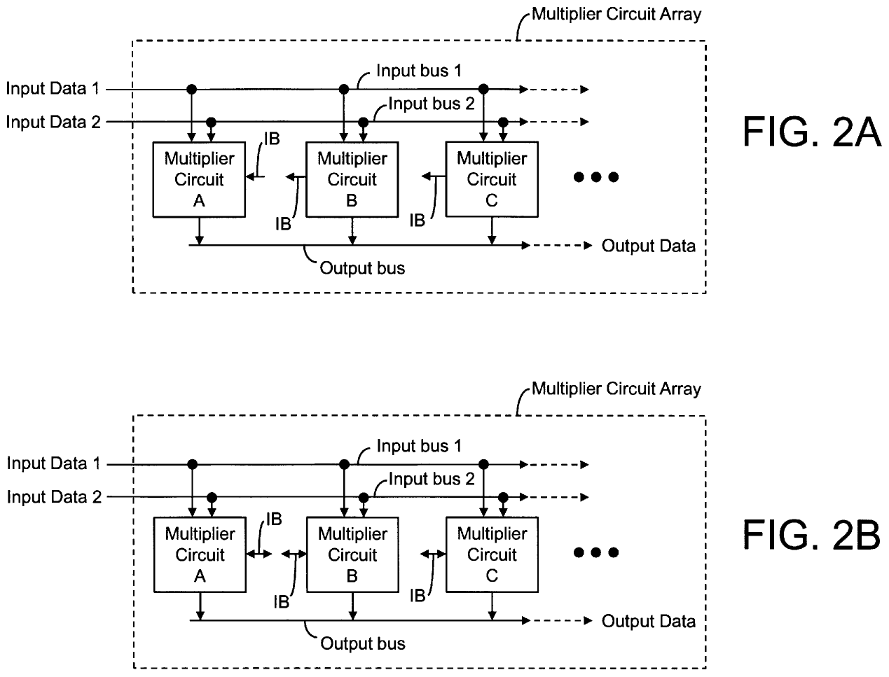

As noted above, each multiplier circuit of the multiplier circuit array may be a complete and fully functional/capable multiplier circuit or may be a partial multiplier circuit including only certain or selected circuitry of a complete and fully functional/capable multiplier circuit (e.g., omission of: (i) circuitry to perform the multiply operation corresponding to sign fields and exponent fields of the operands or (ii) circuitry to perform the multiply operation corresponding to the fraction fields of the operands). In one embodiment, the multiplier circuit array may include a plurality of multiplier circuits wherein one or more of the multiplier circuit(s) is/are incorporated or embedded into another of multiplier circuit of the multiplier circuit array. For example, with reference to FIGS. 3A-3C, in one embodiment, the multiply core of a first multiplier circuit is partially or fully incorporated into the circuitry of a second multiplier circuit (in the illustrative embodiment, multiplier circuit A) of the multiplier circuit array. In this regard, multiplier circuit B may be a complete and fully functional/capable multiplier circuit or may be a partial multiplier circuit including only certain or selected circuitry of a complete and fully functional/capable multiplier circuit (e.g., the multiply core wherein other circuity may be omitted, e.g., (i) circuitry to perform the multiply operation corresponding to sign fields and exponent fields of the operands, (ii) circuitry to perform the multiply operation corresponding to the fraction fields of the operands (e.g., circuitry that is configured to perform two's complement multiplication), and/or (iii) rounding circuitry (if any)).

Notably, the discussions relative to FIGS. 1A-1D, and 2A and 2B (e.g., characteristics of the multiplier circuits, multiply cores, format types, and precisions, bus(es), and/or the implementation or performance of the multiply operation) are applicable to the exemplary embodiments of FIGS. 3A-3D and, for the sake of brevity, will not be repeated. Moreover, although not illustrated, in one embodiment, the input data 1 (first operand, e.g., image data) and input data 2 (second operand, e.g., filter weights) in the embodiments of FIGS. 2A and 2B are provided to the multiplier circuits of the multiplier circuit array via a multiplexed bus (see, e.g., FIGS. 1C, 1D and 3D).

With reference to FIG. 4, in one embodiment, the multiplier circuit array of the multiply circuitry of the present inventions may be incorporated and/or implemented in a multiplier-accumulator circuit. In this exemplary embodiment, the input data (e.g., image data and filter weights) are provided to the plurality of multiplier circuits via input bus(es) and the output of the multiplier circuitry (i.e., the product of the input data) is provided to accumulator circuit wherein it is added to additional data (accumulation data) and output as output data.

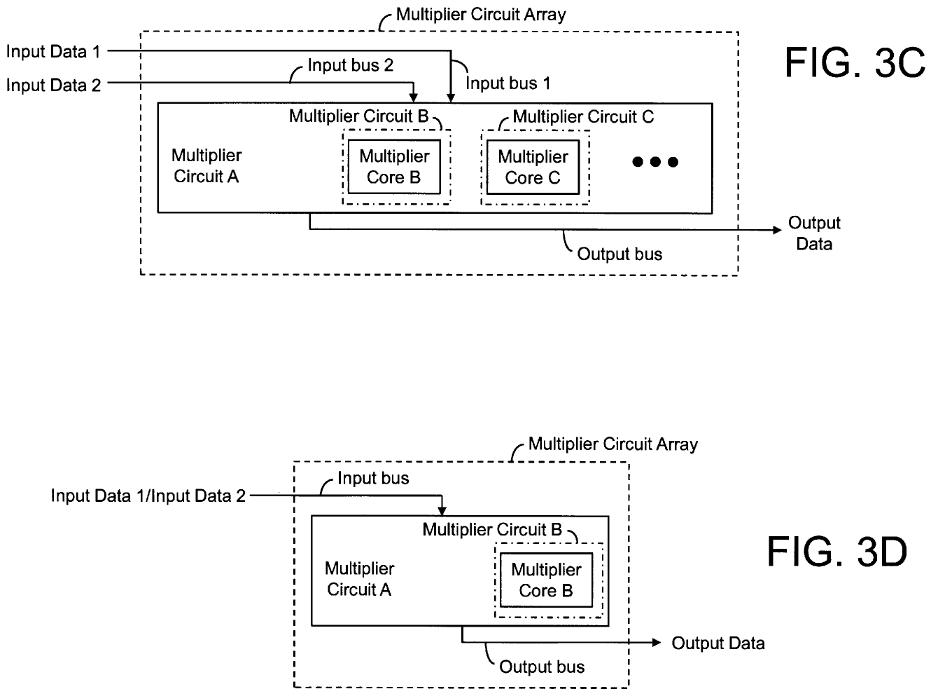

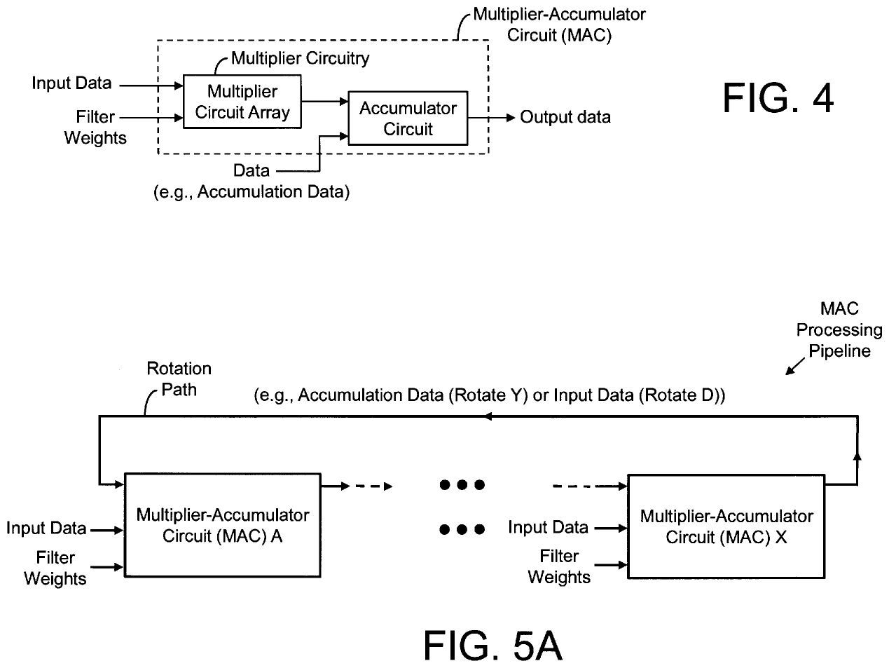

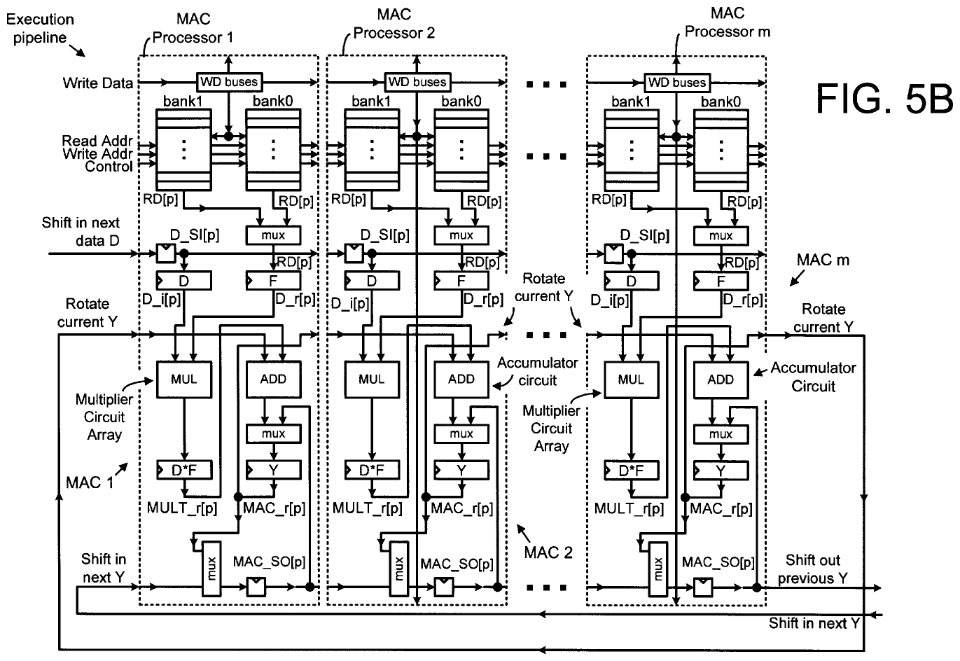

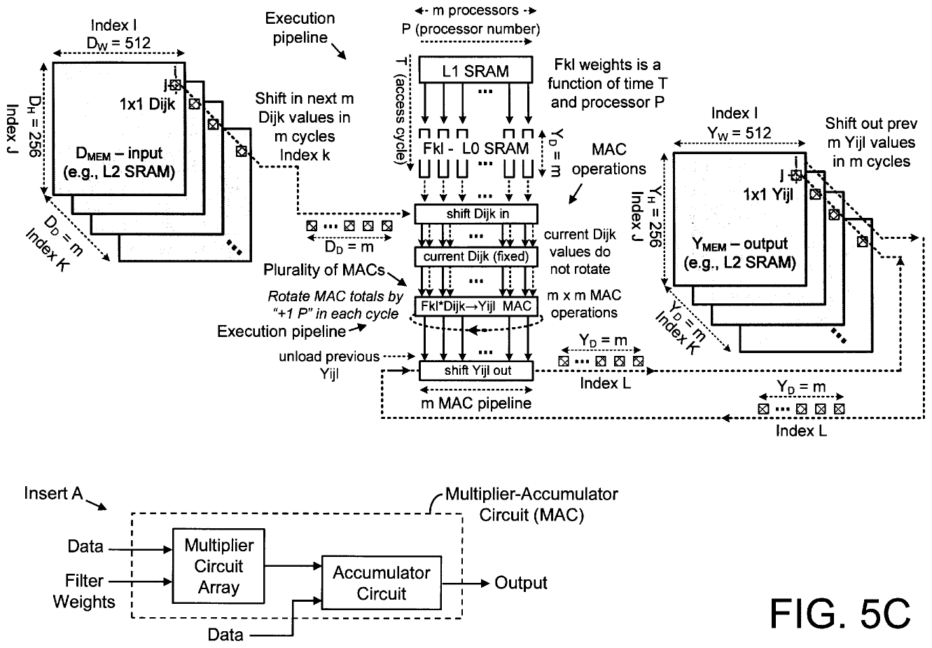

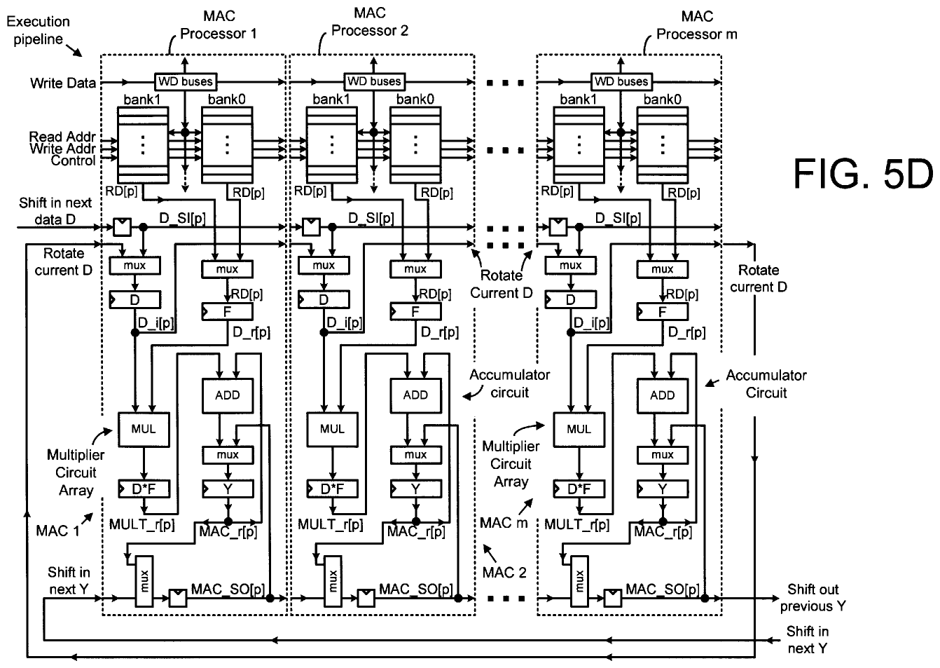

With reference to FIG. 5A, in one embodiment, a plurality of multiplier-accumulator circuits (e.g., as illustrated in FIG. 4), each multiplier-accumulator circuit including a multiplier circuit array may be organized or arranged in a linear execution or processing pipeline including, for example, execution circuitry employing one or more floating point data formats. In one embodiment, the multiplier-accumulator circuit(s) may include a multiplier circuit array which is configurable to provide a predetermined precision of the resultant multiplication product (output data of the multiplier circuit array). For example, the multiplier circuit array may include a floating point type multiplier circuit and an integer type multiplier circuit. The output data of the multiplier circuit array may be configured to have a floating point data format or an integer data format.

With continued reference to FIGS. 4 and 5A, the output data of the multiplier circuit array may be provided to the accumulator circuit (e.g., which may the same data format type as the output/product of the multiplier circuitry). In one embodiment, the execution or processing pipeline includes a plurality of MACs, each circuit including a multiplier circuit array (e.g., having an identical configuration). For example, the plurality of MACs (each having multiplier circuit array) may be interconnected (in series) to perform the multiply and accumulate operations and/or the pipelining architecture or configuration implemented via connection of MACs. In this pipeline architecture, for example, the plurality of MACs may concatenate the multiply and accumulate operations of the data processing. In another embodiment, the execution or processing pipeline includes a plurality of MACs, wherein the multiplier circuit array in one or more of the MACs of the pipeline include a different configuration (e.g., output data having different precisions and/or data formats).

Notably, as mentioned above, the MAC (including a multiplier circuit array) of the present inventions may be employed and/or implemented in the circuitry described and/or illustrated in U.S. patent application Ser. Nos. 16/545,345, 17/019,212 and/or 17/391,082. Here, the multiplier circuit array of the present inventions may be incorporated into the multiplier circuitry of the MAC described and/or illustrated in the '345, '212 and '082 applications to, for example, facilitate concatenating the multiply and accumulate operations, and reconfiguring the circuitry thereof and operations performed thereby (see, e.g., the exemplary embodiments illustrated in FIGS. 1A-1C of U.S. patent application No. 16/545,345). In this way, each MAC includes a multiplier circuit array to, for example, process data (e.g., image data) in a manner whereby the processing and operations are performed as described herein. As noted above, the '345, '212 and '082 applications are incorporated by reference herein in their entirety.

In addition, the MACs (each including a multiplier circuit array) of the processing pipelines or architectures, and circuitry to configure and control such pipelines/architectures, described and/or illustrated in U.S. patent application Ser. No. 17/019,212. In this regard, the multiplier circuitry of the MACs may include the multiplier circuit array described and illustrated herein; again, as noted above, the '212 application is incorporated by reference herein in its entirety.

Further, the multiplier-accumulator circuits (having the multiplier circuit array of the present inventions described and/or illustrated herein) may be interconnected into execution or processing pipelines as described and/or illustrated in U.S. patent application Ser. Nos. 17/212,411 and 17/391,082; the '411 and '082 applications are incorporated by reference herein in their entirety. In one embodiment, the circuitry configures and controls a plurality of separate multiplier-accumulator circuits (each having a multiplier circuit array of the present inventions) or rows/banks of such multiplier-accumulator circuits (which are interconnected, for example, in series (such rows/banks thereof are referred to, at times, as clusters) to pipeline multiply and accumulate operations. In one embodiment, the plurality of multiplier-accumulator circuits (having the multiplier circuit array) may include a plurality of registers (including a plurality of shadow registers) wherein the circuitry also controls such registers to implement or facilitate the pipelining of the multiply and accumulate operations performed by the multiplier-accumulator circuits to increase throughput of the multiplier-accumulator execution or processing pipelines in connection with processing the related data (e.g., image data). (See, e.g., '345 application).

In another embodiment, the interconnection of the pipeline or pipelines (each including a plurality of multiplier-accumulator circuits (having the multiplier circuit array of the present inventions described and/or illustrated herein) may be configurable or programmable to provide different forms of pipelining, as described and/or illustrated in the '411 and '082 applications. Here, the pipelining architecture provided by the interconnection of the plurality of multiplier-accumulator circuits (having the multiplier circuit array of the present inventions described and/or illustrated herein) may be controllable or programmable. In this way, a plurality of multiplier-accumulator circuits, each circuit having a multiplier circuit array of the present inventions described and/or illustrated herein, may be configured and/or re-configured to form or provide the desired processing pipeline(s) to process data (e.g., image data). For example, with reference to U.S. patent application Ser. Nos. 17/212,411 and 17/391,082, in one embodiment, control/configure circuitry may configure or determine the multiplier-accumulator circuits having multiplier circuit array described herein, or rows/banks of interconnected multiplier-accumulator circuits having a multiplier circuit array described herein are interconnected (in series) to perform the multiply and accumulate operations and/or the pipelining architecture or configuration implemented via connection of multiplier-accumulator circuits (or rows/banks of interconnected multiplier-accumulator circuits). Thus, in one embodiment, the control/configure circuitry configures or implements an architecture of the execution or processing pipeline by controlling or providing connection(s) between such multiplier-accumulator circuits and/or such rows of interconnected multiplier-accumulator circuits—each of which include one or more multiplier circuit array embodiments described herein.

With reference to FIG. 5B, the data processing circuitry of an exemplary illustrative embodiment includes a plurality of multiplier-accumulator circuits (MACs)—each MAC including a multiplier circuit array (“MUL”) to perform multiplication operations in, for example, a floating point format, and accumulator circuit (“ADD”) to perform operations in, for example, a floating point format (e.g., the same floating point format as multiplier circuit array). In one embodiment, the MAC may be coupled to two dedicated memory banks to store at least two different sets of filter weights—each set of filter weights associated with and used in processing a set of data) wherein each memory bank may be alternately read for use in processing a given set of associated data and alternately written after processing the given set of associated data.

With reference to FIGS. 5B and 5C, in one embodiment, input data (e.g., image pixel values) are accessed in or read from memory (e.g., an L2 memory—such as SRAM). The input data may or may not be in a floating point format (e.g., 16 bit—“FP16”) that is correlated to or consistent with the format employed by the illustrative MAC processing circuitry (here, multiplier circuit array thereof). If not, circuitry may convert the data format of the input data to a suitable or a predetermined format (e.g., FP16). For example, if the input data (e.g., image data) have been generated by an earlier filtering operation and/or stored in memory (e.g., SRAM such as L2 memory) after generation/acquisition, such data may be in a 24 bit floating point format (FP24—24 bits for sign, exponent, fraction). Under this circumstance, in one embodiment, the data/pixels may be converted (e.g., on-the-fly—i.e., immediately prior to such data processing) into an FP16 format, which may be the format employed by the multiplier circuitry in connection with the multiplication operation.

With continued reference to FIGS. 5B, the input data are shifted into the MAC via loading register “D_SI”. In one embodiment, such data is thereafter parallel-loaded into the data register “D”. The data are then input into the multiplier circuit array (identified as “MUL” in FIG. 5B to perform, in a floating point format, the multiplication operation of the input data with the filter weight.

The filter weights, in one exemplary embodiment, are accessed in or read from L0 memory (such as SRAM). In one embodiment, the filter weights may be previously loaded from L2 memory to L1 memory, and then from L1 memory to L0 memory. (See FIG. 5C). In one embodiment, the filter weights are stored in L2 memory in an FP8 format (8 bits for sign, exponent, fraction). The filter weight values, in this embodiment, are read from memory (L2—SRAM memory), converted on-the-fly into an FP16 data format, for storage in the L1 and L0 memory levels. Thereafter, the filter weights are loaded into the filter weight register “F” and available/accessible to the multiplier circuitry of the execution circuitry/process of the data processing circuitry.

Alternatively, in one embodiment, the filter weights are stored in memory (e.g., L2 memory) in an FP16 format (16 bits for sign, exponent, fraction). The filter weight values, in this embodiment, are read from memory (L2—SRAM memory) and directly stored in the L1 and L0 memory levels. Thereafter, the filter weights are loaded into the filter weight register “F” and are available/accessible to the multiplier circuitry to implement the multiplication operation of the execution circuitry/process of the data processing circuitry. In yet another embodiment, the filter weight values are read from memory (e.g., L2 or L1—SRAM memory) and directly loaded into the filter weight register “F” for use by the multiplier circuit array of the execution circuitry/process of the MAC processors.

Notably, other numerical precisions and/or data formats may be employed for the various values which are to be processed—the values that are described in this exemplary embodiment represent the precision (e.g., minimum precision) that is practical for a floating point format.

With continued reference to FIG. 5B, the multiplier circuitry reads the “D” and “F” values and performs a multiplication operation (i.e., multiplies the input data and the filter weight). The product or output of the multiplier circuitry is output to the accumulation stage via the “D*F” register. In one exemplary embodiment, the output data of the multiplier circuitry is in a floating point data format (e.g., 24 bit—“FP24” format) and is thereafter accumulated (with FP24 precision) via the accumulator circuit (identified as “ADD”) and stored in the “Y” register.

In one embodiment, a plurality of outputs of the accumulator circuit may be accumulated. That is, after each result “Y” has accumulated a plurality of products, the accumulation totals may be parallel-loaded into the “MAC-SO” registers. Thereafter, the accumulation data may be serially shifted out (i.e., output) during a subsequent or the next execution sequence (e.g., to memory).

Notably, with continued reference to FIG. 5B, the plurality of multiplier-accumulator circuits of the execution or processing pipeline are connected in series and form a ring configuration or architecture. Here, each MAC, implementing the multiplier circuit array of the present inventions, is configurable to connect to two other MAC circuits of the plurality of MAC circuits that are interconnected in the ring configuration/architecture. For example, in one embodiment of the ring configuration/architecture, the output of the accumulator of a first MAC circuit (e.g., MAC 1) is input into the accumulator of a second MAC circuit (e.g., MAC 2) and the output of a last MAC circuit of the chain (e.g., MAC m) is input into the accumulator of the first MAC circuit (e.g., MAC 1).

With reference to FIGS. 5B and 5C, in one embodiment, the present inventions are implemented in one or more execution or processing pipelines (e.g., for image filtering) having a plurality of MACs (e.g., disposed on an integrated circuit), each including a multiplier circuit array. In this exemplary embodiment, the multiplier-accumulator circuits (e.g., 64 MACs) are organized or implemented in an execution pipeline that is configured in a linearly connected pipeline architecture. In this configuration/architecture, Dijk data is fixed in place during execution and Yijl data that rotates during execution. The 64×64 Fkl filter weights are distributed across L0 memory (in this illustrative embodiment, 64 L0 SRAMs—one L0 SRAM in each MAC of the 64 MAC processing circuit of the pipeline). In each execution cycle, 64 Fkl values will be read and provided to the MAC circuits. The Dijk data values are stored or held in one processing element during the 64 execution cycles after being loaded from the Dijk shifting chain—which is connected to DMEM memory (here, L2 memory—such as SRAM).

In this exemplary embodiment, during processing, the Yijlk MAC values are rotated through all 64 MAC processing circuits during the 64 execution cycles after being loaded from the Yijk shifting chain (see YMEM memory), and will be unloaded with the same shifting chain. Further, “m” (e.g., 64 in the illustrative embodiment) MAC processing circuits in the execution pipeline operate concurrently whereby the multiplier-accumulator processing circuits perform m×m (e.g., 64×64) multiply-accumulate operations in each m (e.g., 64) cycle interval (here, a cycle may be nominally 1 ns). Thereafter, a next set of input pixels/data (e.g., 64) is shifted-in and the previous output pixels/data is shifted-out during the same m (e.g., 64) cycle interval. Notably, each m (e.g., 64) cycle interval processes a Dd/Yd (depth) column of input and output pixels/data at a particular (i,j) location (the indexes for the width Dw/Yw and height Dh/Yh dimensions). The m (e.g., 64) cycle execution interval is repeated for each of the Dw*Dh depth columns for this stage. In this exemplary embodiment, the filter weights or weight data are loaded into memory (e.g., the L1/L0 SRAM memories) from, for example, an external memory or processor before the stage processing started (see, e.g., the '345, '212 and '082 applications). In this particular embodiment, the input stage has Dw=512, Dh=256, and Dd=128, and the output stage has Yw=512, Yh=256, and Yd=64. Note that only 64 of the 128 Dd input are processed in each 64×64 MAC execution operation.

With continued reference to FIG. 5C, the method implemented by the configuration/architecture illustrated may accommodate arbitrary image/data plane dimensions (Dw/Yw and Dh/Yh) by adjusting the number of iterations of the basic 64×64 MAC accumulation operation that are performed. The loop indices “I” and “j” are adjusted by control and sequencing logic circuitry to implement the dimensions of the image/data plane. Moreover, the method may also be adjusted and/or extended to handle a Yd column depth larger than the number of MAC processing circuits (e.g., 64 in this illustrative example) in the execution pipeline. In one embodiment, this may be implemented by dividing the depth column of output pixels into blocks (e.g., 64), and repeating the MAC accumulation of FIG. 5C for each of these blocks.

Indeed, the method illustrated in FIG. 5C may be further extended to handle a Dd column depth larger than the number of MAC processing circuits (64 in this illustrative example) in the execution pipeline. This may be implemented, in one embodiment, by initially performing a partial accumulation of a first block of 64 data of the input pixels Dijk into each output pixel Yijl. Thereafter, the partial accumulation values Yijl are read (from the memory Yₘₑₘ) back into the execution pipeline as initial values for a continuing accumulation of the next block of 64 input pixels Dijk into each output pixel Yijl. The memory which stores or holds the continuing accumulation values (e.g., L2 memory—such as SRAM) may be organized, partitioned and/or sized to accommodate any extra read/write bandwidth to support the processing operation.

With reference to FIGS. 5D and 5E, in another pipeline architecture embodiment, the input data of rotate current D (input data D_i[p]) is transferred or transported from one MAC to another MAC via a rotation path during the execution cycles of the processing sequence. In this illustrated pipeline architecture, the operation is similar to the embodiments of FIGS. 5B and 5C, however, in this configuration, the input data are rotated, transferred or moved, on a cycle-by-cycle basis, from one MAC of the linear pipeline to the immediately following MAC whereas, during processing, the accumulation values generated by each MAC are not rotated, transferred or moved from one MAC of to the immediately following MAC but are maintained or stored in the MAC for use in subsequent processing.

With continued reference to FIGS. 5D and 5E, a plurality of MACs are interconnected into a linear processing pipeline wherein the input data values are rotated, transferred or moved through the MACs of the pipeline (before, during or at the completion of an execution cycle of a execution sequence). In this regard, in operation, after input or loading of the initial data input values into the MACs of the linear pipeline, the input data values are rotated, transferred or moved, on a cycle-by-cycle basis, from one MAC of the linear pipeline to the immediately following MAC of the pipeline and employed in the multiply operation of the multiplier circuit array of that next MAC of the processing pipeline. As noted above, however, the accumulation values generated by each MAC are maintained, stored or held, during each execution cycle of the execution sequence, in respective MAC and used in the accumulation operation of the associated accumulator circuit thereof. Thus, in this embodiment, the input data are rotated, transferred or moved, on a cycle-by-cycle basis, from one MAC of the linear pipeline to the immediately following MAC (of the pipeline) whereas, during processing, the accumulation values generated by each MAC are not rotated, transferred or moved from one MAC of to the immediately following MAC but are maintained, held or stored in the MAC for use in subsequent processing during the associated execution cycles of the set of execution cycles (i.e., execution sequence).

In one embodiment, the multiplier circuit array of each MAC receives input data (Dijk) and an associated filter weight Fkl (e.g., from memory—see, e.g., FIG. 5D, Memory L0, RD(p)). After the initial load of input data (from “Shift in next data D”), the input data values are rotated, transferred or moved, on a cycle-by-cycle basis, from one MAC of the linear pipeline to the immediately following MAC of the pipeline and employed in the multiply operation of the multiplier circuit array of that next MAC of the processing pipeline. Here, MAC processor includes a shifting chain (D_SI[p]) for the input data (Dijk data). In operation, the next Dijk data is shifted in while the current Dijk data is employed in the current execution cycle of the execution sequence. In one embodiment, the current Dijk data is shifted between the D_i[p] registers in the MAC processors during the current set of execution cycles of the sequence (i.e., they will move (rotate) during execution). Concurrently, the MACs receive the associated filter weights (associated with the input data) wherein the multiplier circuit array performs a multiply operation and, upon completion, provide the product result to an accumulator circuit. Notably, the Fkl filter weights are distributed across the L0 SRAMs (there is one L0 SRAM in each of the MAC processors or processing elements) wherein in each execution cycle, the Fkl values will be read and passed to the MAC processors.

In this embodiment, the linearly connected MAC pipeline is configured such that Yijl data is fixed in a MAC processor during execution whereas the input data (Dijk data) rotates during execution through or between the MAC processors. That is, the Yijl accumulation values are not output (moved or rotated), during or after each cycle of the execution sequence (i.e., set of associated execution cycles), to the immediately following MAC and employed in the accumulation operation. With that in mind, the accumulator circuit receives the previous accumulation value output therefrom (see MAC_r[p]). Thus, in each execution cycle, the Fkl value in the D_r[p] register is multiplied by the Dijk value in the D_i[p] register, via the multiplier circuit array, and the result/product is loaded in the MULT_r[p] register. In the next pipeline cycle this D*F value is added to the Yijl accumulation value in the local MAC_r[p] register (in the same or associated MAC processor) and the result is loaded in the MAC_r[p] register. This is repeated for the execution cycles of the current execution sequence. Here, the immediately previous accumulation value are provided to the accumulator circuit and employed in the accumulation operation.

With continued reference to FIGS. 5D and 5E, regarding the execution cycles (and sets thereof), each MAC processor includes the shifting chain (D_SI[p]) for the data input (Dijk data). In this embodiment, an initial input data value (Dijk data) is shifted into each of the MACs and an execution cycle is performed. Here, the Dijk data is stored in the D_i[p] register during the execution cycles of the current execution sequence. After completion of the execution cycle, the input data values (“D”) are rotated, transferred or moved from one MAC (e.g., MAC Processor 1) of the linear pipeline to the immediately following MAC (e.g., MAC Processor 2) of the execution pipeline (see, D_i[p]) wherein the multiplexer may be controlled to select the input of the that rotated input data value (“Rotate current D”) which is then employed in the multiply operation of the multiplier circuit array of the MAC (e.g., MAC Processor 2) of the processing pipeline.

In this embodiment, the MACs are configured such that the output of the accumulator circuit (“ADD”) is input back into the accumulator circuit (“ADD”) of the associated MAC (see, MAC_r[p]) and employed in the accumulation operation. Moreover, the output of each accumulator circuit (“ADD”) of the MACs is not rotated, transferred or moved to the immediately following MAC of the linear processing pipeline (compare FIGS. 5B and 5C)—rather, the input data values (“D”) are rotated, transferred or moved (e.g., before, during or at the completion of each execution cycle of the execution sequence (i.e., set of associated execution cycles)) through the plurality of serially connected MACs of the pipeline such that, in operation, after input of the initial data input values into the MACs of the linear pipeline (see “Shift in next D”), each input data value (see “Rotate current D”) that is input into a MAC is output before, during or at the completion of each execution cycle to the immediately following MAC of the linear pipeline and employed in the multiplication operation of the multiplier circuit array (“MUL”) of that immediately following MAC.

The MAC processors also include a shifting chain (MAC_SO[p]) for preloading the Yijl sum. In this embodiment, each MAC also uses the shifting chain (MAC_SO[p]) for unloading or outputting the Yijl sums (final accumulation values). The previous Yijl sums are shifted out (i.e., rotated, transferred) while the next Yijl sums are shifted in. Notably, in this embodiment, the Yijl shifting chain (MAC_SO[p]) may be employed to both preloading and unloading. Thus, in this embodiment, the linearly connected pipeline architecture may be characterized by Yijl data that is fixed in place during execution and Dijk data that rotates during execution. That is, the input data values (Dijk data values) rotate through all of the MAC processors or MACs during the associated execution cycles of the execution sequence after being loaded from the Dijk shifting chain. As noted above, in this embodiment, the Yijlk accumulation values will be held or maintained in a MAC processor during the associated execution cycles of the execution sequence—after being loaded from the Yijk shifting chain and the final Yijlk accumulation values will be unloaded via the same shifting chain.

Notably, these techniques, which generalize the applicability of the MAC execution pipeline (in this exemplary embodiment, 64×64) of, for example, FIGS. 5A-5E, may also be utilized or extended to the generality of the additional methods that will be described, for example, in other portions of this application. Indeed, this application describes an inventive method or technique to design a floating point execution unit/circuit in a standard description language (e.g., Verilog language).

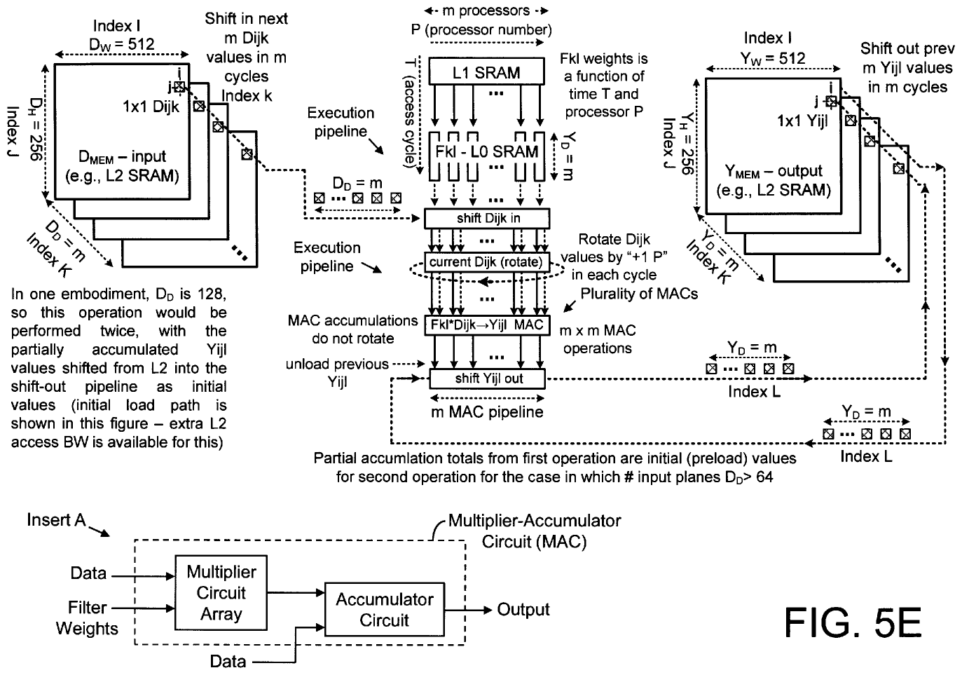

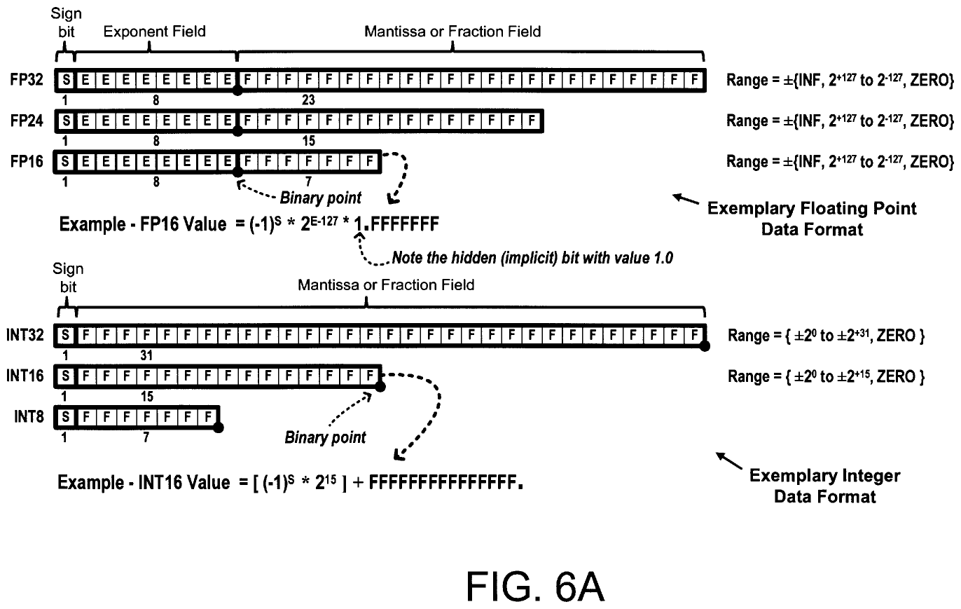

With reference to FIG. 6A, the present inventions may be employed in connection with (i) floating point data formats having different widths or lengths, including respective ranges, and different precisions, (i.e., FPxx where: xx is an integer and indicates the total number of bits (sign, exponent, mantissa/fraction), e.g., x=16, 24, 32) and/or (ii) fixed point data formats such as integer data formats having different widths or lengths, including respective ranges, and different precisions (i.e., INTxx where: xx is an integer and indicates the total number of bits (sign and mantissa/fraction), e.g., x=8, 16, 32). The floating point data formats illustrated utilize a signed-magnitude numeric format for the sign field and fraction field. The fraction field has a most-significant weight of 0.5, and a hidden (implicit) bit with a weight of 1.0 is added (i.e. normalized fraction). The exponent field is a two's complement numeric format to which a bias of 127 is added. The three fixed point values utilize a two's complement numeric format. The minimum and maximum exponent values are reserved for special values/operands (NAN, INF, DNRM, ZERO). In one embodiment, the largest magnitude negative and positive values are reserved as saturation values to avoid overflow errors of the numeric format.

With reference to FIG. 6B, exemplary floating point data formats of different widths or lengths, including respective ranges, and different precisions. Notably, except for the different mantissa precision widths, the formats are similar to, for example, a standard IEEE 754 32 bit floating point data format. FIG. 6B illustrates exemplary floating point data format that may be employed in connection with at least certain aspects of the present inventions. The configuration method allows precisions in the range of FP14 through FP39—used for storing and transporting data of the floating point format. A normalized mantissa/fraction field has an additional implicit/hidden bit with a weight of 1.0.

For the purposes of illustration, a 32 bit floating point data format (FP32) is often employed to explain or describe certain circuitry, operation thereof, and/or methods of certain aspects of certain features of the present inventions including in the context of the multiply operation and type of multiplier circuit of the multiplier circuit array. Similarly, an integer data format (e.g., an 8 bit integer data format (INT8), a 16 bit integer data format (INT16), a 24 bit integer data format (INT24), and 32 bit integer data format (INT32)) is often employed to explain or describe certain circuitry, operation thereof, and/or methods of certain aspects of certain features of the present inventions including in the context of the multiply operation and type of multiplier circuit of the multiplier circuit array. The inventions, including the embodiments thereof described and/or illustrated herein, are not limited to (i) particular floating point data format(s), particular fixed point data format(s), precisions thereto, block/data width, data path width, bandwidths, values, processes and/or algorithms illustrated.

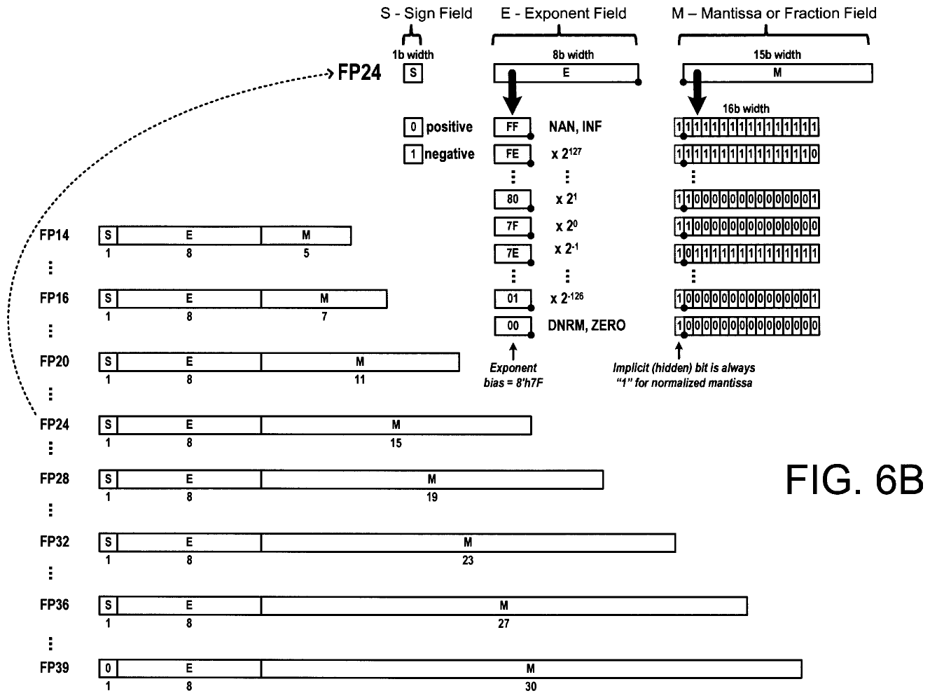

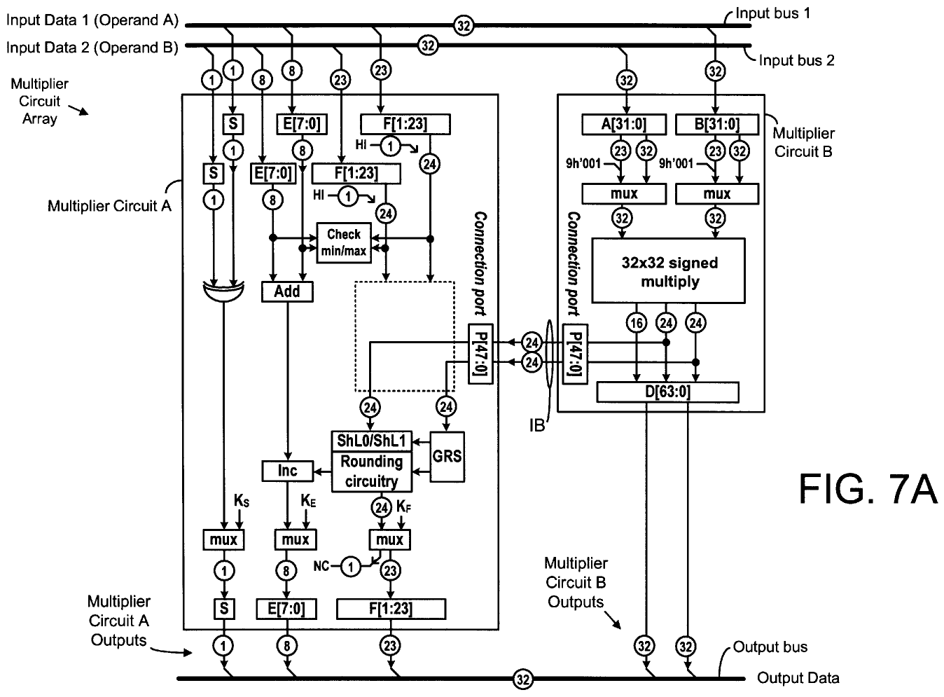

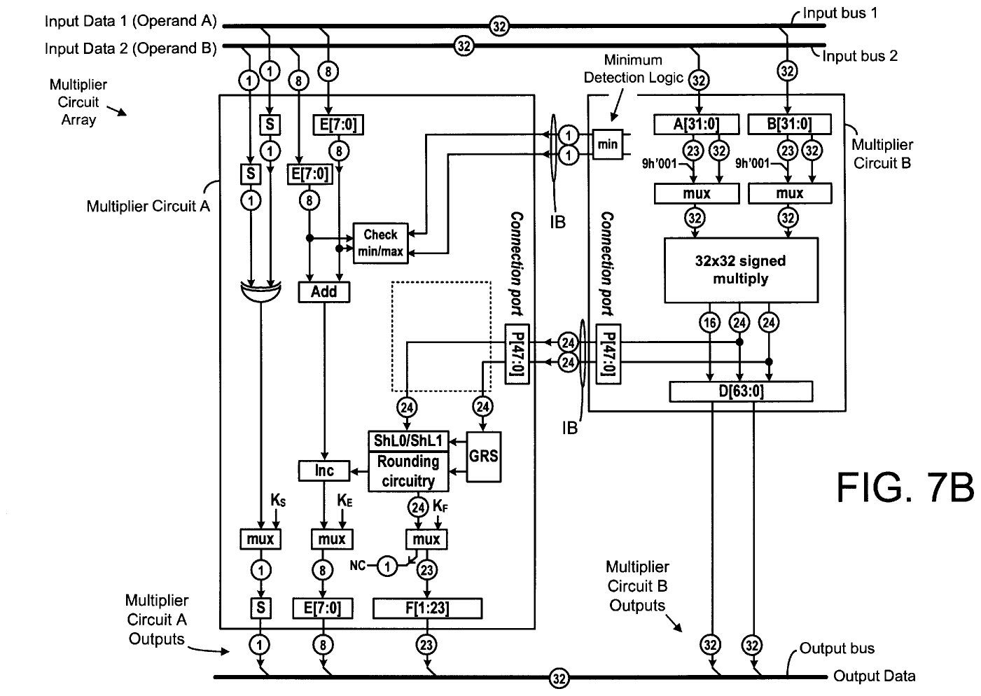

With reference to FIGS. 7A-7C, in one embodiment, the multiplier circuit array includes two multiplier circuits, interconnected via a dedicated point-to-point bus (interconnection bus (IB)), to perform multiply operations in connection with input data A and input data B (e.g., image data and filter weights, respectively). In one embodiment, the input data have a floating point data format (e.g., such as 16, 24 and 32 bits)). Moreover, the multiplier circuit A may be a floating point type circuit (e.g., 32 bit) and multiplier circuit B an integer type circuit (e.g., a 24 bit or 32 bit). In this embodiment, multiplier circuit A performs a portion of the multiply operation pertaining to the values of the sign bit fields and the exponent fields of, for example, the input data and filter weights (which, in this embodiment, are in a floating point data format). The multiplier circuit B performs a portion of the multiply operation pertaining to the values of fraction fields of, for example, the input data and filter weights. In operation, multiplier circuit A obtains the sign field and exponent field of each of input data A (operand A) and input data B (operand B) and performs the multiplication operation in relation thereto. The multiplier circuit B obtains the fraction field of input data A and input data B and performs the multiplication operation in relation thereto. In one embodiment, multiplier circuit B outputs the product thereof to multiplier circuit A via the interconnection bus IB.

Notably, each multiplier circuit of the multiplier circuit array may be a partial multiplier circuit including only certain or selected circuitry of a complete and fully functional/capable multiplier circuit (e.g., omission of: (i) circuitry to perform the multiply operation corresponding to sign fields and exponent fields of the operands or (ii) circuitry to perform the multiply operation corresponding to the fraction fields of the operands). Here, the multiplier circuit A processes or performs a portion(s) of the multiply operation (i.e., multiply operations of the values of the sign bit fields and the exponent fields of the input data and filter weights) and may not include circuitry to perform the portion(s) of the multiply operation that is performed by multiplier circuit B (i.e., circuitry associated with the multiply operation of the values of fraction fields of, for example, the input data and filter weights). Similarly, the multiplier circuit B processes or performs a different portion(s) of the multiply operation (i.e., values of fraction fields of, for example, the input data and filter weights) and may not include circuitry to perform the portion(s) of the multiply operation that is performed by multiplier circuit A (i.e., multiply operations of the values of the sign bit fields and the exponent fields of, for example, the input data and filter weights).

With continued reference to FIGS. 7A-7C, in one embodiment, the multiplier circuit A is a floating point type multiplier circuit that performs the multiply operation based on a floating point data format, and the multiplier circuit B is an integer type multiplier circuit that performs multiply operation based on an integer format. In one embodiment, the multiplier circuits A and B include the same multiplication precision (32 bit) and, in another embodiment, the multiplier circuits A and B include different multiplication precisions (e.g., a first multiplier circuit may be an x-bit floating point type (e.g., 32 bit floating point type multiplier circuit) and a second multiplier circuit may be a y-bit integer type (wherein y does not equal x; e.g., a 32 bit integer type multiplier circuit, a 24 bit integer type multiplier circuit, or a 16 bit integer type multiplier circuit).

The multiply block/operation may be separated, divided and/or broken into two pieces: a 24×24 multiply core and everything else. The interconnection bus (e.g., a 48 conductor bus P[47:0]) provides communication between the pieces of the multiply block to facilitate communication of the product of the fraction field (via the integer type multiplier—multiplier circuit B) to the multiplier circuit A. In the exemplary embodiment, the 32×32 bit multiply core may also be a 24×24 bit multiply core employed for the fractional field multiplication (e.g., circuitry that is configured to perform two's complement multiplication). Where a 32×32 bit multiply core of the integer type multiplier circuit (multiplier circuit B) is employed, the lower or LSB 48 bits of the 64 bit product are routed to the interconnection bus (via the connection port P[47:0]).

in one embodiment, the multiply operation (FP32) implemented by the multiplier circuit array begins by loading the two 32 bit operands (from input bus 1 and input bus 2) into the multiplier circuit A and simultaneously loading the two operands into multiplier circuit B. Where the multiplier circuit B is a 32 bit integer multiplier type, a constant 9h′001 is input into the MSBs. The multiplier circuit B multiplies the two fractional field of the operands and generates a product thereof. In addition, the multiplier circuit A processes the 1b sign and 8b exponent fields.

With continued reference to FIG. 7A, in one embodiment, circuitry of the multiplier circuit A checks the 23b fraction fields of the two operands (operand A and operand B) for the minimum value. The multiplier circuit A receives the product of the fractional fields from multiplier circuit B (via the interconnection bus IB). The multiplier circuit A may normalize and round the product of the fractional fields as well as check for special cases. The multiplier circuit A thereafter outputs the output product data (i.e., the product of operand A and operand B), for example, in a floating point data format, on the output bus.

In addition to the multiply core to perform operations with respect to the fractional fields of the operands, other logic circuitry may be disposed in multiplier circuit B (versus in multiplier circuit A). For example, with reference to FIG. 7B, in one embodiment, “min” logic circuitry is disposed in multiplier circuit B to determine if the fraction values are a minimum value (e.g., 23 h′000000). The “min” logic circuitry may determine whether the value of the fraction field of either input data are special operands such as zero (ZERO), infinity (INF) or not-a-number (NAN). In response, the multiplier circuit B transmits data to circuitry in multiplier circuit A to respond appropriately. Notably, in this embodiment, the number of conductors of the interconnection bus IB is less (relative to the embodiment illustrated in FIG. 7A).

While the embodiment illustrated in FIG. 7B would also not pass a NAN (not-a-number) operand to the output result, in another embodiment (not illustrated), circuitry may detect a NAN and thereby causing the other operand to 24′h800000 which would then facilitate transmitting a NAN to multiplier circuit A via the interconnection bus IB (e.g., P[47:24]). Indeed, in yet another embodiment, (also not illustrated) the circuitry would not include “min” detection logic and treat a NAN operand as if it was an INF operand (the infinity overflow saturation value), and treat a DNRM operand (denormalized value—smallest normalized (NRM) value and the zero (ZRO) value) as if it was an ZRO operand (the zero underflow value).

With reference to FIG. 7C, in another embodiment, certain logic circuitry associated with the rounding circuitry is disposed in multiplier circuit B. In this embodiment, GRS logic circuitry is disposed in multiplier circuit B to assess the data for rounding purposes and, in response, provide information employed to perform round-to-nearest-even product result. The number of conductors of the interconnection bus (IB) of the multiplier circuit array, in this embodiment, is smaller (relative to the embodiment illustrated in FIG. 7A) because the GRS logic circuitry, disposed in multiplier circuit B, determines if the rounding data and communications such data to the rounding circuitry in multiplier circuit A and, in response, transmits considerably less data directed to the rounding operation. For example, in this embodiment, a portion of the interconnection bus IB (i.e., P[23:0] interface) has been “replaced” by GRS interface—including three conductor interface, namely P[23] and P[22] product bits (renamed to “G” and “R”), and the P[21:0] product bits have been logically ORED together (in the GRS logic in multiplier circuit B) to form or generate the “S” bit. These three bits contain the information employed by the rounding circuitry (in multiplier circuit A) to, for example, perform round-to-nearest-even for the FP32 result.

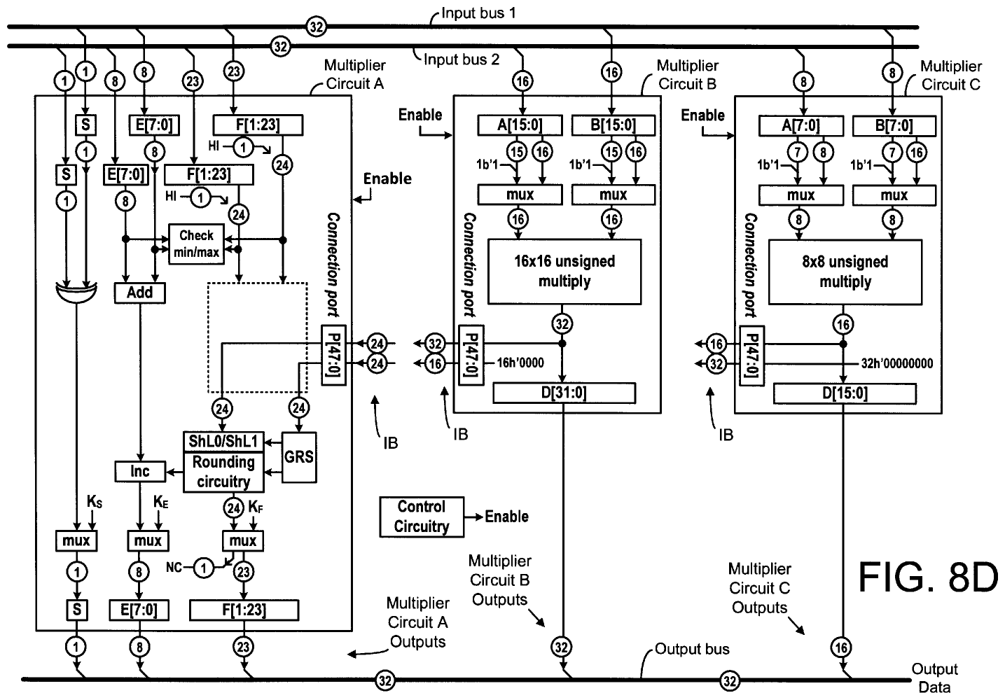

In one embodiment, the rounding circuitry may also be disposed in multiplier circuit B. That is, either/both multiplier circuits of the multiplier circuit array may include rounding circuitry to round the resultant product of the multiply operation to generate or provide a predetermined bit length, size or precision of the fraction field of the output data. For example, where the output data includes a floating point data format having a bit length, size or precision of 32 bits, the multiply operation of the two operands may generate more bits corresponding to the fraction field and suitable or defined for 32 bit floating point data. Here, the rounding circuitry generates or provides rounding data which is employed to round the fraction field to an appropriate bit length, size or precision corresponding to the data format (e.g., in the context of a 32 bit floating point data format, a 23 bit fraction field). Thus, in one embodiment, the rounding circuitry generates data/information to round the resultant product of the fraction fields. In one embodiment, the rounding circuitry may be separated into a plurality of segments so that the resultant/product may be rounded to a fraction size of bits (e.g., 8, 16, 24) that corresponds to a result of multiplier circuitry and/or the size or width of the output data. (See, FIGS. 9A-9C).

Notably, the embodiment of FIGS. 7B and 7C may be combined wherein the “min” detection logic and the GRS logic are disposed or located in multiplier circuit B. Indeed, whether illustrated or not, the various supporting circuitry (e.g., “min” detection logic, GRS logic, rounding circuitry, etc.) may be disposed in multiplier circuit A and/or multiplier circuit; all combination thereof are intended to fall within the scope of the present inventions. It should be further noted that certain circuitry may be located in the multiplier circuit A and/or multiplier circuit B (i.e., circuitry associated with the multiply operation corresponding to the values of the sign bit fields and the exponent fields, rounding, min/max detection, etc.)—all combinations and permutations are intended to fall within the scope of the present inventions.

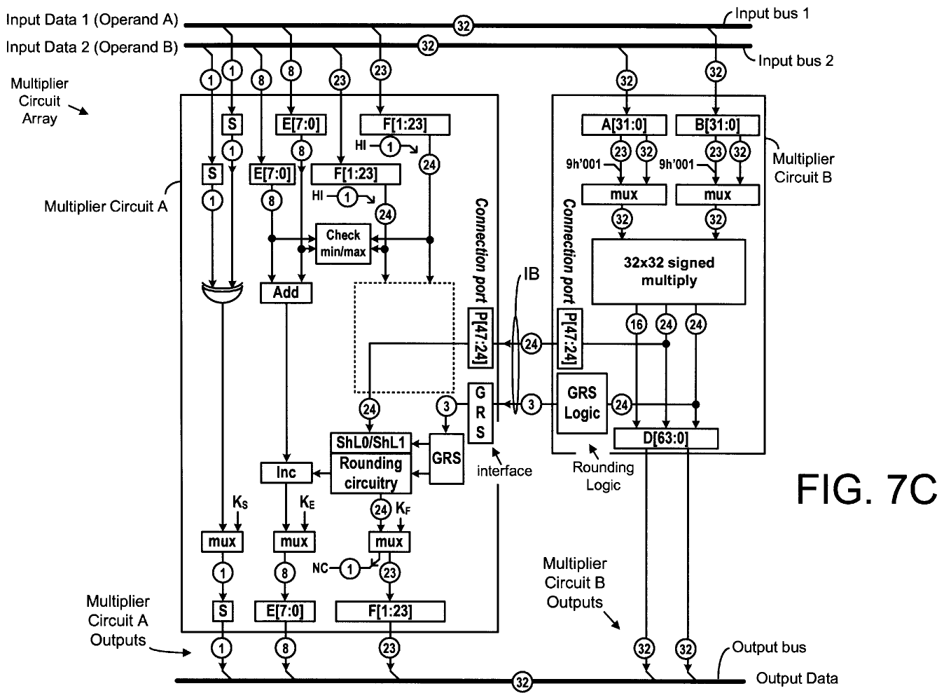

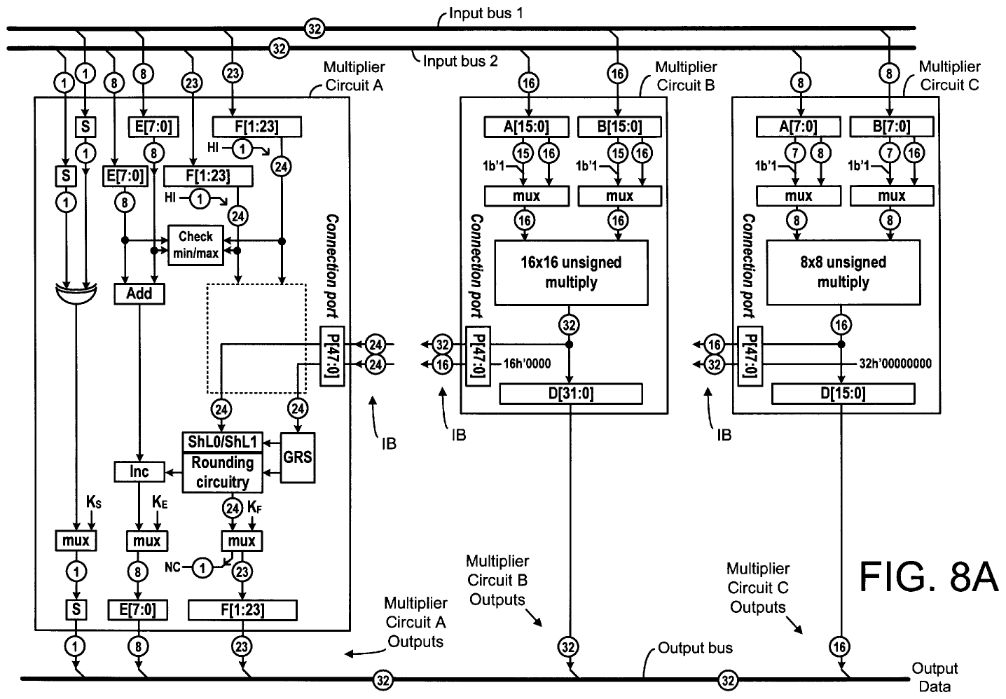

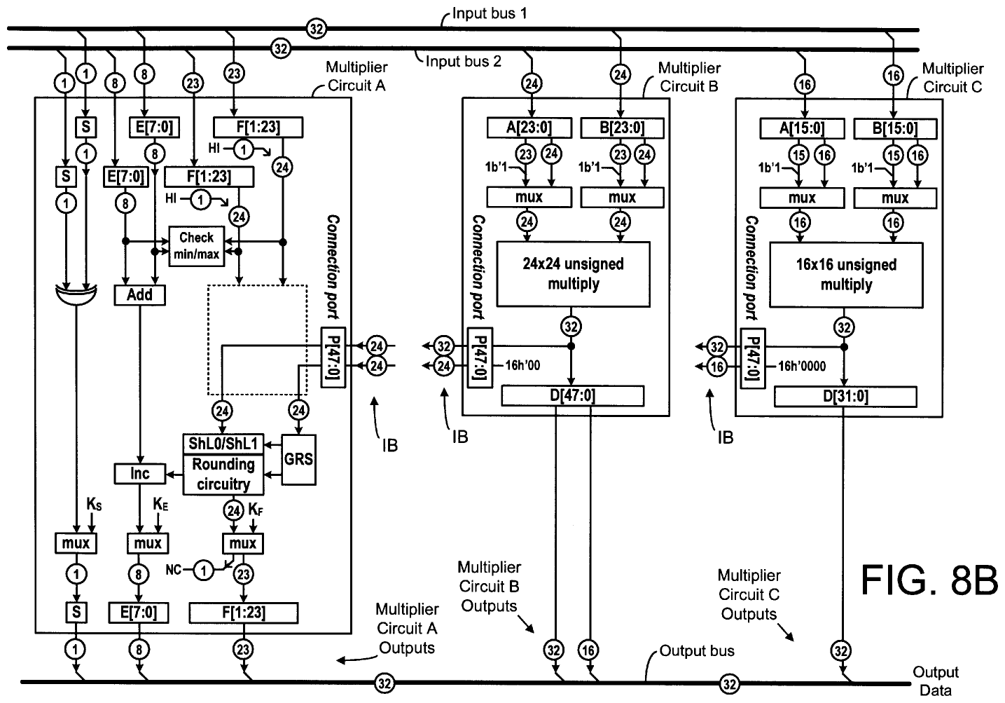

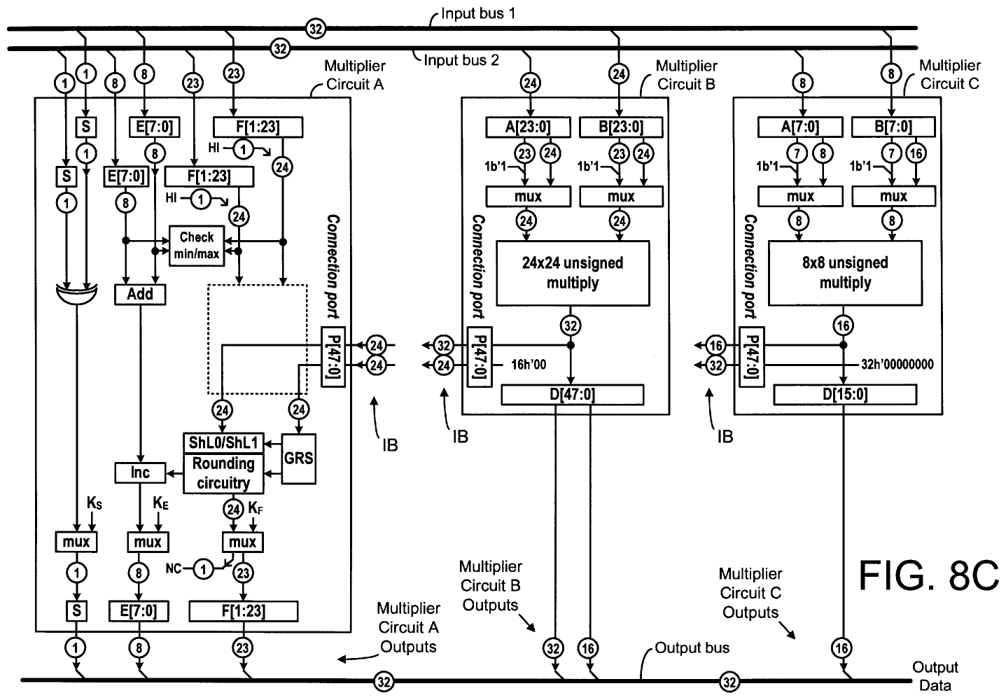

With reference to FIGS. 8A-C, in another exemplary embodiment, the multiplier circuit array may include three (or more) multiplier circuits including, for example, multiplier circuit A may be an x-bit floating point type (e.g., a 32 bit floating point type multiplier circuit) which processes or performs a first portion of the multiply operation (e.g., values of the sign bit fields and the exponent fields of, for example, the input data and filter weights), multiplier circuit B may be a y-bit integer type (e.g., a 16 bit or 24 bit integer type multiplier circuit) which processes or performs one or more portions of the multiply operation (e.g., multiply operation of the fraction fields of, for example, the input data and the fraction field portions of the filter weights) and/or multiplier circuit C of a z-bit integer type (e.g., an 8 bit or 16 bit integer type multiplier circuit) which processes or performs one or more portions of the multiply operation (e.g., multiply operation of the fraction fields of, for example, the input data and the fraction field portions of the filter weights). In one embodiment, multiplier circuit B and multiplier circuit C may both perform multiply operations of different portions of fraction fields of the operands; in another embodiment, only one of multiplier circuit B or multiplier circuit C may perform multiply operations of fraction fields of the operands.

As noted above, each multiplier circuit of the multiplier circuit array may be a complete and fully functional/capable multiplier circuit or may be a partial multiplier circuit including only certain or selected circuitry of a complete and fully functional/capable multiplier circuit (e.g., omission of: (i) circuitry to perform the multiply operation corresponding to sign fields and exponent fields of the operands or (ii) circuitry to perform the multiply operation corresponding to the fraction fields of the operands). For example, with reference to FIG. 8A, in one embodiment, multiplier circuit A may be a 32 bit floating point type multiplier circuit which processes or performs a first portion of the multiply operation (e.g., values of the sign bit fields and the exponent fields of, for example, the input data and filter weights, in addition to rounding and min/max detection), multiplier circuit B may be a 16 bit integer type multiplier circuit which processes or performs one or more other portions of the multiply operation (e.g., values of fraction fields of, for example, the input data and filter weights) and multiplier circuit C may be an 8 bit integer type multiplier circuit which processes or performs one or more other portions of the multiply operation (e.g., values of fraction fields of, for example, the input data and filter weights having a 16 bit FP data format). In this exemplary embodiment, multiplier circuit A may not include circuitry to perform the multiply operation of the values of fraction fields and multiplier circuits B and C may not include circuitry to perform the portions of the multiply operation that is to be performed by multiplier circuit A (e.g., circuitry associated with the multiply operation corresponding to the values of the sign bit fields and the exponent fields, rounding, min/max detection, etc.). The various locations of such circuitry (i.e., circuitry associated with the multiply operation corresponding to the values of the sign bit fields and the exponent fields, rounding, min/max detection, etc.) is applicable to all of the embodiment hereof. That is, certain circuitry may be located in any or all of the multiplier circuits (i.e., circuitry associated with the multiply operation corresponding to the values of the sign bit fields and the exponent fields, rounding, min/max detection, etc.)—all combinations and permutations are intended to fall within the scope of the present inventions.

With reference to FIGS. 8A-8C, multiplier circuits A is connected to multiplier circuits B and C via conductors of interconnection bus IB (e.g., point-to-point and/or multi-drop)). The interconnection bus (IB) may be a point-to-point dedicated bus. Alternatively, the interconnection bus (IB) may be a multi-drop bus wherein multiplier circuits A, B and C are connected.

In one embodiment, at least one of the multiplier circuits of the multiply circuit array outputs data of the product resulting from the multiply operation (e.g., the output of the multiply operation of the values of fraction fields of, for example, the input data and filter weights) to another multiplier circuit of the multiply circuit array. Notably, in one embodiment, the conductors may also communicate control or control type data (e.g., rounding information/data, outputs from fraction detection logic to detect, for example, special values/operands such as ZRO (zero), NAN (not a number), EOVFL (exponent overflow), EUNFL (exponent underflow) and/or INF (infinity)).

With reference to FIGS. 8A-8C and 9A-9C, rounding circuitry of the multiplier circuit array may include circuitry to implement rounding for one or more different lengths or sizes of the fractional fields (e.g., x=4, 8, 16, 24 bits, and/or y=8, 16, 24, 32 bits, and x≠y). Here, the rounding circuitry is capable of implementing rounding operations for one or more different sizes or widths of the input data (each having different sizes or widths of the values of the fractional fields) and/or a plurality of different sizes or widths of the output data (each having different sizes or widths of the values of the fractional fields). For example, with reference to FIGS. 8B and 9C, where multiplier circuit C performs a 16 bit multiplication of the fractional fields of input data A and input data B, the multiply circuit A may employ the rounding circuitry associated with the 16 bit data length. In another embodiment, with reference to FIGS. 8C and 9C, where multiplier circuit B performs a 24 bit multiplication of the fractional fields of input data A and input data B, the multiply circuit A may employ the rounding circuitry associated with the 24 bit data length; however, where the multiplier circuit C performs a 8 bit multiplication of the fractional fields of input data A and input data B, the multiply circuit A may employ the rounding circuitry associated with the 8 bit data length. Here, the rounding circuitry may be separated into a plurality of segments so that the product may be rounded to a fraction size of bits (e.g., 4, 8, 16, 24, 32) that corresponds to a result of multiplier circuitry and/or the size or width of the output data. Notably, the GRS logic may also be modified to implement the proper rounding decision is made for the fraction sizes of the product.

With continued reference to FIGS. 8A-8C, the multiplier circuits may accommodate a plurality of ranges of lengths or sizes of the fractional fields of the input operands (e.g., 8, 16, 24 bits). For example, the multiplier circuits may accommodate input data corresponding to a floating point data format of FP16, FP24, and FP32. In one embodiment, there is a “mask” cell which includes the multiplexing logic to insert or place zeroes into the unused bit positions. Alternatively the functionality of the mask cell may be implemented by logic external to the multiplier circuit array.

The multiplier circuit array of FIGS. 8A-8C may be configured in connection with several different bit sizes or widths, or implement different multiplication blocks/cores. For example, with reference to FIG. 8A, multiplier circuit B may perform 16×16 unsigned multiply and thereby accommodate or be employed in connection with the multiplication of floating point data format of FP16 and FP24. Alternatively, multiplier circuit C may perform 8×8 unsigned multiply and thereby accommodate or be employed in connection with the multiplication of floating point data format of FP16 and FP8

With reference to FIG. 8D, in one embodiment, each multiplier circuit of the multiplier circuit array may include enable/disable circuitry and/or select/deselect circuitry to facilitate configure the multiplier circuit array to implement a predetermined multiply operation (e.g., operations performed having a predetermined data format and using a predetermined precision to, for example, provide output data (resultant product) having a predetermined format and predetermined precision). For example, where one or more of the multiplier circuit(s) of the multiplier circuit array is/are employed or incorporated in the multiply operations, such multiplier circuit(s) is/are enable and configured to process or perform a portion of the multiply operation (e.g., values of the sign bit fields and the exponent fields of, for example, the input data and filter weights) and one or more other multiplier circuit(s) of the multiplier circuit array perform one or more other portions of the multiply operation (e.g., values of fraction fields of, for example, the input data and filter weights). In the event that one or more of the multiplier circuit(s) of the array is/are not employed or utilized in performance of the multiply operations, such one or more of the multiplier circuit(s) is/are deselected and, in one embodiment, disabled (e.g., de-coupled from the input and output bus and/or electrically powered-down).

The configuration of the multiplier circuit array may be user or system defined and/or may be one-time programmable/configurable (e.g., at manufacture) or more than one-time programmable/configurable (e.g., (i) at or via power-up, start-up or performance/completion of the initialization sequence/process sequence, and/or (ii) in situ (i.e., during operation of the integrated circuit), at manufacture, and/or at or during power-up, start-up, initialization, re-initialization, configuration, re-configuration or the like. In one embodiment, control circuitry is employed to program/configure the multiplier circuit array including the plurality of multiplier circuits. The control circuitry, in one embodiment, programs/configures the multiplier circuit array one-time; in another embodiment, the control circuitry programs/configures the multiplier circuit array more than one-time (i.e., multiple times). For example, the control circuity may receive select and/or enable signals from internal or external circuitry (i.e., external to the one or more integrated circuits—for example, a host computer/processor) including one or more data storage circuits (e.g., one or more memory cells, register, flip-flop, latch, block/array of memory), one or more input pins/conductors, a look-up table LUT (of any kind), a processor or controller and/or discrete control logic. The control circuitry, in response thereto, may employ such signal(s) to enable or disable selected multiplier circuits of the multiplier circuit array and thereby configure the multiplier circuitry of, for example, the MAC or MACs of a data processing pipeline, to implement the multiply operations. The control circuitry may configure the multiplier circuitry in situ and/or at or during power-up, start-up, initialization, re-initialization, configuration, re-configuration or the like. Indeed, in one embodiment, control circuitry may evaluate the input data and, based thereon, implement or select a configuration of the multiplier circuit array to provide the appropriate configuration to implement or provide a predetermined precision and data format of the resultant multiplication product (output data).

For example, with reference to FIG. 8D, the multiplier circuit array may include, multiplier circuit A (a 32 bit floating point type multiplier circuit), which processes a first portion of the multiply operation (e.g., values of the sign bit fields and the exponent fields of, for example, the input data and filter weights), multiplier circuit B (a 16 bit integer type multiplier circuit), which processes one or more portions of the multiply operation (e.g., values of fraction fields of, for example, the input data and filter weights) and a third multiplier circuit (an 8 bit integer type multiplier circuit) which processes one or more portions of the multiply operation (e.g., values of fraction fields of, for example, the input data and filter weights). Where the precision and data format of the input data and filter weights are 16 bit floating point data format, control circuitry may enable multiplier circuit A and one of multiplier circuits B or C to implement the multiply operations of the multiplier circuitry. Here, multiplier circuit A may perform or implement the multiply operation in connection with the values of the sign bit fields and the exponent fields of, for example, the input data and filter weights, and multiplier circuit B or multiplier circuit C may perform or implement the multiply operation in connection with the values of fraction fields of the input data and filter weights (in this example, a 8×8 multiply operation). Notably, however, it may be more efficient (power and timing) to employ the 8 bit integer type multiplier circuit given the difference in bit size of the multiply core circuit. Thus, the control circuitry may enable and select the multiplier circuits A and C of the multiplier circuit array which communicate via the interconnect conductors disposed therebetween.

In another embodiment, where the precision and data format of the input data and filter weights have a 24 bit floating point data format, control circuitry may enable multiplier circuits A and B of the multiplier circuit array to implement the multiply operations of the multiplier circuitry. Here, multiplier circuit A may perform or implement the multiply operation in connection with the values of the sign bit fields and the exponent fields of, for example, the input data and filter weights, and multiplier circuit B may perform or implement the multiply operation in connection with the values of fraction fields of the input data and filter weights (in this example, a 16×16 multiply operation). Notably, multiplier circuit C (in this exemplary embodiment, an 8 bit integer type multiplier circuit), does not have the capacity to efficiently multiply the 15 bit values of each fraction field of the input data and filter weights. Thus, the control circuitry enables multiplier circuits A and B (and/or disables or deselects multiplier circuit C).

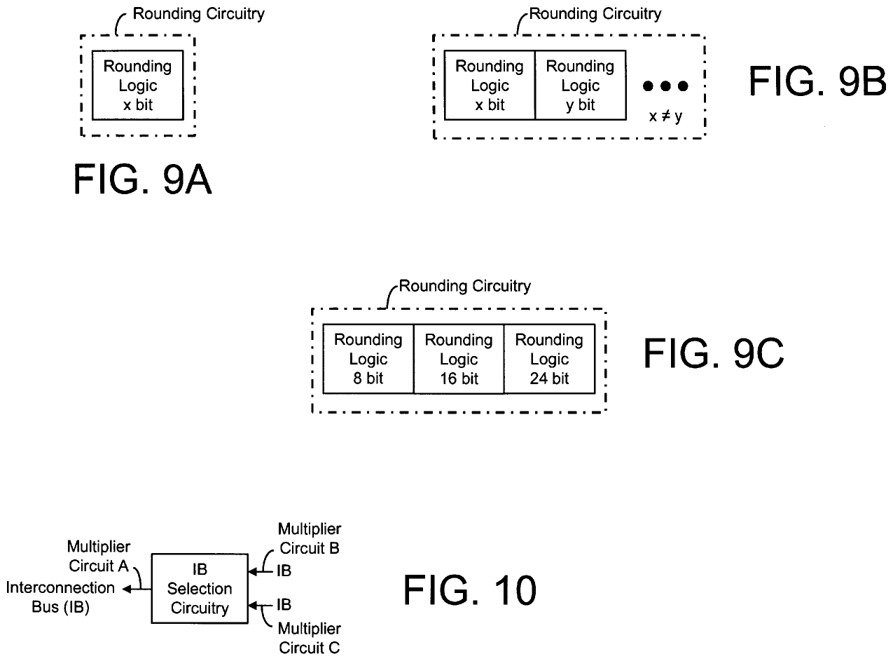

As discussed above, the multiplier circuits of the multiplier circuit array may be programmed/configured via control circuitry, for example, in situ (i.e., during operation of the integrated circuit), at manufacture, and/or at or during power-up, start-up, initialization, re-initialization, configuration, re-configuration or the like. Notably, in one embodiment, interconnection bus (IB) selection circuitry (see, FIG. 10) may be employed to selectively interconnect multiplier circuit B and/or multiplier circuit C to the interconnection bus (IB) and multiplier circuit A based on, for example, which of multiplier circuit B or multiplier circuit C is enabled/employed during performance of the multiplication operation by the multiplier circuit array.

As mentioned above, the multiplier circuit array of the present inventions may be incorporated and/or implemented in one or more (or all) multiplier-accumulator circuits of an execution or processing pipeline including execution circuitry employing one or more floating point data formats. In another aspect of the present inventions, the multiplier-accumulator circuit(s) may include a multiplier circuit array (which, in one embodiment, is configurable to provide a predetermined precision of the resultant multiplication product (output data)). The multiplier circuit array may include a floating point type multiplier and an integer type multiplier. The output of the multiplier circuit array, having a floating point data format, may be provided to the accumulator circuit, which is a floating point type accumulator. In one embodiment, the execution or processing pipeline includes a plurality of multiplier-accumulator circuits, each circuit including a multiplier circuit array (e.g., having an identical configuration). For example, the plurality of multiplier-accumulator circuits (each having multiplier circuit array) may be interconnected (in series) to perform the multiply and accumulate operations and/or the pipelining architecture or configuration implemented via connection of multiplier-accumulator circuits. In this pipeline architecture, for example, the plurality of multiplier-accumulator circuits may concatenate the multiply and accumulate operations of the data processing.

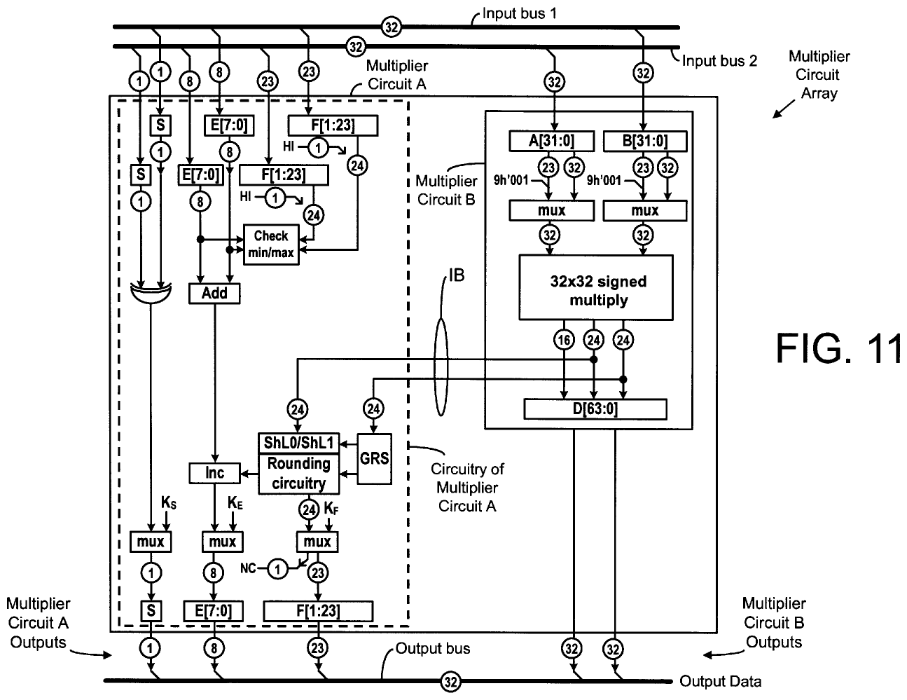

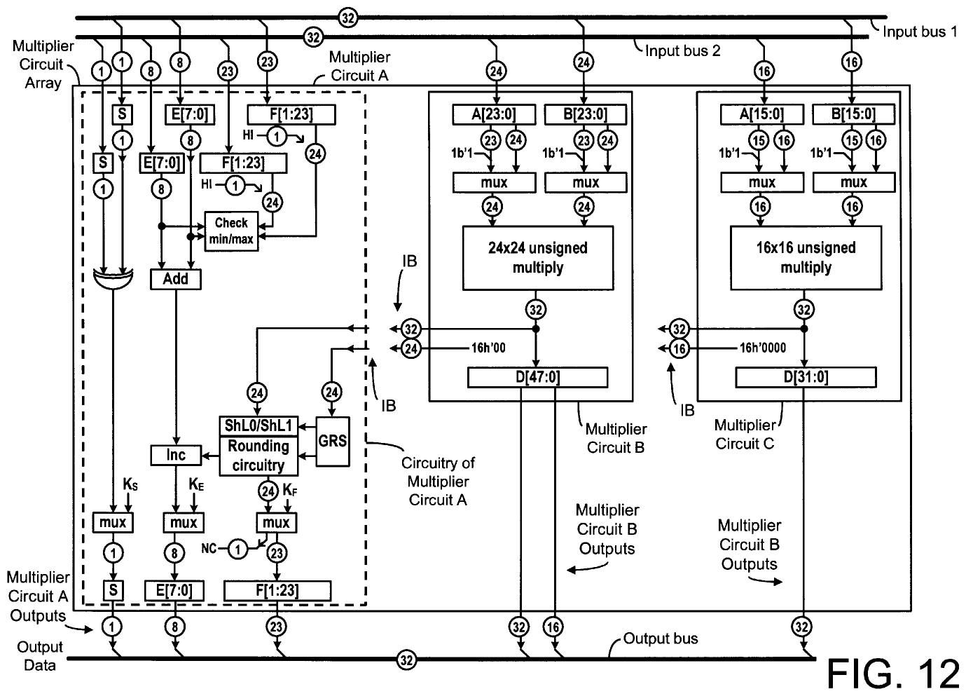

The multiplier circuit array may include a plurality of multiplier circuits wherein one or more of the multiplier circuit(s) is/are incorporated or embedded into another of multiplier circuit of the multiplier circuit array. For example, with reference to FIG. 11, the multiply core of multiplier circuit B may be partially or fully incorporated into the multiplier circuit A of the multiplier circuit array. Similarly, with reference to FIG. 12, the multiply core of multiplier circuit B and the multiply core of multiplier circuit C may be partially or fully incorporated into the multiplier circuit A of the multiplier circuit array. As mentioned above, the multiplier circuit B and/or multiplier circuit C may be a complete and fully functional/capable multiplier circuit or may be a partial multiplier circuit including only certain or selected circuitry of a complete and fully functional/capable multiplier circuit (e.g., the multiply core wherein other circuity may be omitted, e.g., (i) circuitry to perform the multiply operation corresponding to sign fields and exponent fields of the operands, (ii) circuitry to perform the multiply operation corresponding to the fraction fields of the operands, and/or (iii) rounding circuitry (if any)).

Notably, the multiplier circuit array of the present inventions may be employed and/or implemented in the multiplier-accumulator circuit, MAC pipelines, and other circuitry described and/or illustrated in U.S. patent application Ser. No. 16/545,345. Here, the multiplier circuit array of the present inventions may be incorporated into or employed in the multiplier circuitry of the multiplier-accumulator circuit described and/or illustrated in the '345 application to, for example, facilitate concatenating the multiply and accumulate operations, and reconfiguring the circuitry thereof and operations performed thereby (see, e.g., the exemplary embodiments illustrated in FIGS. 1A-1C of U.S. patent application Ser. No. 16/545,345); in this way, each multiplier-accumulator circuit includes a multiplier circuit array to, for example, process data (e.g., image data) in a manner whereby the processing and operations are performed as described herein. Notably, the '345 application are incorporated by reference herein in their entirety.

Further, the multiplier circuit array of the present inventions may also be employed or be implemented in the circuitry and techniques multiplier-accumulator execution or processing pipelines (and methods of operating such circuitry) having circuitry to implement Winograd type processes to increase data throughput of the multiplier-accumulator circuit and processing—for example, as described and/or illustrated in U.S. patent application No. 16/796,111, both of which are hereby incorporated by reference in its entirety. In this regard, each multiplier-accumulator circuit described in the aforementioned '111 application, and pipeline(s) including such multiplier-accumulator circuit, may include a multiplier circuit array of the present inventions, to facilitate concurrently processing data to, for example, increase throughput of the data processing and overall pipeline.

In addition thereto, or in lieu thereof, the multiplier circuit array of the present inventions may also be employed and/or implemented in the circuitry of the multiplier-accumulator execution or processing pipelines (and methods of operating such circuitry) to process data, concurrently or in parallel, to increase throughput of the pipeline—for example, as described and/or illustrated in U.S. patent application Ser. No. 16/816,164; the '164 application are hereby incorporated by reference in its entirety. Here, a plurality of processing or execution pipelines, each pipeline having a plurality of multiplier-accumulator circuits that include a multiplier circuit array of the present inventions, may concurrently process data to, for example, increase throughput of the data processing and overall pipeline. Control or configure circuitry may be programmed to configure the multiplier-accumulator pipelines (wherein the individual multiplier-accumulator circuits include multiplier circuit array of the present inventions) to implement the concurrent and/or parallel processing techniques.

The multiplier circuit array of the present inventions may also be employed and/or implemented in the multiplier-accumulator circuits employed in the processing pipelines or architectures, and circuitry to configure and control such pipelines/architectures, described and/or illustrated in U.S. patent application Ser. No. 17/019,212. In this regard, the multiplier circuitry of the multiplier-accumulator circuits may include the multiplier circuit array described and illustrated herein; the '212 application are incorporated by reference herein in their entirety.

Moreover, the present inventions may be implemented in the circuitry, function and operation of enhancing the dynamic range of the filter weights or coefficients as described and/or illustrated in U.S. patent application Ser. No. 17/074,670. That is, the present inventions may use the circuitry and techniques to enhance the dynamic range of the filter weights or coefficients of the '670 application. Such circuitry and techniques may be implemented in connection with the multiply operations performed by the multiplier circuit array of the multiplier-accumulator circuits of the present inventions. Notably, the '670 application are incorporated herein by reference in their entirety.

Further, the multiplier-accumulator circuits (having the multiplier circuit array of the present inventions described and/or illustrated herein) may be interconnected into execution or processing pipelines as described and/or illustrated in U.S. patent application Ser. No. 17/212,411, which, as noted above, is incorporated by reference herein in its entirety. In one embodiment, the circuitry configures and controls a plurality of separate multiplier-accumulator circuits (each having a multiplier circuit array of the present inventions) or rows/banks of such multiplier-accumulator circuits (which are interconnected, for example, in series (such rows/banks thereof are referred to, at times, as clusters) to pipeline multiply and accumulate operations. In one embodiment, the plurality of multiplier-accumulator circuits (having the multiplier circuit array) may include a plurality of registers (including a plurality of shadow registers) wherein the circuitry also controls such registers to implement or facilitate the pipelining of the multiply and accumulate operations performed by the multiplier-accumulator circuits to increase throughput of the multiplier-accumulator execution or processing pipelines in connection with processing the related data (e.g., image data). (See, e.g., '345, '212 and '082 applications).

In another embodiment, the interconnection of the pipeline or pipelines (each including a plurality of multiplier-accumulator circuits (having the multiplier circuit array of the present inventions described and/or illustrated herein) may be configurable or programmable to provide different forms of pipelining, as described and/or illustrated in U.S. patent application Ser. No. 17/212,411). Here, the pipelining architecture provided by the serial interconnection of the plurality of multiplier-accumulator circuits (having the multiplier circuit array of the present inventions described and/or illustrated herein) may be controllable or programmable. In this way, a plurality of multiplier-accumulator circuits, connected in series wherein each circuit having a multiplier circuit array of the present inventions described and/or illustrated herein, may be configured and/or re-configured to form or provide the desired processing pipeline(s) to process data (e.g., image data). For example, with reference to the '411 application, in one embodiment, control/configure circuitry may configure or determine the multiplier-accumulator circuits having multiplier circuit array described herein, or rows/banks of interconnected multiplier-accumulator circuits having a multiplier circuit array described herein are interconnected (in series) to perform the multiply and accumulate operations and/or the pipelining architecture or configuration implemented via connection of multiplier-accumulator circuits (or rows/banks of interconnected multiplier-accumulator circuits). Thus, in one embodiment, the control/configure circuitry configures or implements an architecture of the execution or processing pipeline by controlling or providing connection(s) between such multiplier-accumulator circuits and/or such rows of interconnected multiplier-accumulator circuits—each of which include one or more multiplier circuit array embodiments described herein.

Moreover, the multiplier-accumulator circuits (having the multiplier circuit array of the present inventions described and/or illustrated herein) may be employed in the processing pipelines as described and/or illustrated in U.S. patent application Ser. Nos. 17/376,415 and 17/391,082; the '415 and '082 applications are incorporated by reference herein in its entirety. In short, the circuitry and techniques to implement the programmable granularity circuitry and techniques described and/or illustrated in the '415 application as well as the filter circuitry and techniques described and/or illustrated in the '082 application may be modified to employ the multiplier-accumulator circuits having one or more multiplier circuit array embodiments described and/or illustrated herein. Thus, in one embodiment, multiplier-accumulator circuits having one or more multiplier circuit array embodiments are implemented in the circuitry and techniques described and/or illustrated in the '810 and/or '979 applications.

There are many inventions described and illustrated herein. While certain embodiments, features, attributes and advantages of the inventions have been described and illustrated, it should be understood that many others, as well as different and/or similar embodiments, features, attributes and advantages of the present inventions, are apparent from the description and illustrations. As such, the embodiments, features, attributes and advantages of the inventions described and illustrated herein are not exhaustive and it should be understood that such other, similar, as well as different, embodiments, features, attributes and advantages of the present inventions are within the scope of the present inventions.

Indeed, the present inventions are neither limited to any single aspect nor embodiment thereof, nor to any combinations and/or permutations of such aspects and/or embodiments. Moreover, each of the aspects of the present inventions, and/or embodiments thereof, may be employed alone or in combination with one or more of the other aspects of the present inventions and/or embodiments thereof.

Moreover, although several of the exemplary embodiments and features of the inventions are described and/or illustrated in the context of certain data type and bit size or length of the core(s) of the multiplier circuit(s) (e.g., floating point format (FPxx) and/or integer format (INTxx), the embodiments and inventions are applicable to other formats, precisions sizes and/or lengths. For the sake of brevity, those other formats, precisions or lengths will not be illustrated separately but will be quite clear to one skilled in the art based on, for example, this application. The present inventions are not limited to (i) particular floating point format(s) and lengths thereof, particular fixed point format(s) and lengths thereof, operations (e.g., addition, subtraction, etc.), block/data width or length, data path width, bandwidths, values, processes and/or algorithms illustrated, nor (ii) the exemplary logical or physical overview configurations, exemplary module/circuitry configuration and/or exemplary Verilog code, nor the bit sizes of the cores of the multiplier circuits. The embodiments set forth herein are merely examples of the present inventions.

Further, in one embodiment, the execution pipelines, including MACs having the multiplier circuit arrays, may concurrently process data to increase throughput of the pipeline. For example, in one implementation, the present inventions may include a plurality of separate MAC and a plurality of registers (including, in one embodiment, a plurality of shadow registers) that facilitate pipelining of the multiply and accumulate operations wherein the circuitry of the execution pipelines concurrently process data to increase throughput of the pipeline.

In certain embodiment, conversion circuitry may be employed to convert the data format to a suitable or a predetermined format (e.g., from FP 8 to FP16; or from FP32 to FP24). For example, if the input data (e.g., image data) have been generated by an earlier filtering operation and/or stored in memory (e.g., SRAM such as L2 memory) after generation/acquisition, such data may be in a 24 bit floating point format (FP24—24 bits for sign, exponent, fraction). Under this circumstance, in one embodiment, the data/pixels may be converted (e.g., on-the-fly—i.e., immediately prior to such data processing) into an FP16 format, which may be the format employed by the multiplier circuitry in connection with the multiplication operation. Such circuitry may employ the data conversion circuitry described and/or illustrated in U.S. patent application Ser. No. 17/313,037 (see, e.g., FIG. 2A and associated text and related illustrations), and U.S. Provisional Application Nos. 63/173,948 (see, e.g., FIGS. 4A-11 and associated text) and 63/189,804 (see, e.g., FIGS. 4A-9 and associated text).

Further, control circuitry to implement the configuration of the multiplier circuit array may be partially or entirely resident on the integrated circuit of the processing circuitry or external thereto (e.g., in a host computer or on a different integrated circuit from the MAC circuitry and execution pipelines). As noted above, the configuration of the multiplier circuit array of, for example, the MACs and/or MACs of the execution pipelines, may be user or system defined and/or may be one-time programmable (e.g., at manufacture) or more than one-time programmable (e.g., (i) at or via power-up, start-up or performance/completion of the initialization sequence/process sequence, and/or (ii) in situ (i.e., during operation of the integrated circuit), at manufacture, and/or at or during power-up, start-up, initialization, re-initialization, configuration, re-configuration or the like. In one embodiment, control circuitry may evaluate the input data and, based thereon, implement or select a configuration of the multiplier circuit array (e.g., based on the data format and/or precision of the input data). In response, the control circuitry may receive configuration instruction signals from internal or external circuitry (i.e., external to the one or more integrated circuits—for example, a host computer/processor) including one or more data storage elements (e.g., one or more memory cells, register, flip-flop, latch, block/array of memory), one or more input pins/conductors, a look-up table LUT (of any kind), a processor or controller and/or discrete control logic. The control circuitry, in response thereto, may employ such signal(s) to implement the selected/defined configuration (e.g., in situ and/or at or during power-up, start-up, initialization, re-initialization, configuration, re-configuration or the like) of the multiplier circuit array.

Importantly, the present inventions are neither limited to any single aspect nor embodiment thereof, nor to any combinations and/or permutations of such aspects and/or embodiments. Moreover, each of the aspects of the present inventions, and/or embodiments thereof, may be employed alone or in combination with one or more of the other aspects of the present inventions and/or embodiments thereof.

Further, although the memory cells in certain embodiments are illustrated as static memory cells or storage elements, the present inventions may employ dynamic or static memory cells or storage elements. Indeed, as stated above, such memory cells may be latches, flip/flops or any other static/dynamic memory cell or memory cell circuit or storage element now known or later developed.

Notably, various circuits, circuitry and techniques disclosed herein may be described using computer aided design tools and expressed (or represented), as data and/or instructions embodied in various computer-readable media, in terms of their behavioral, register transfer, logic component, transistor, layout geometries, and/or other characteristics. Formats of files and other objects in which such circuit, circuitry, layout and routing expressions may be implemented include, but are not limited to, formats supporting behavioral languages such as C, Verilog, and HLDL, formats supporting register level description languages like RTL, and formats supporting geometry description languages such as GDSII, GDSIII, GDSIV, CIF, MEBES and any other formats and/or languages now known or later developed. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. Examples of transfers of such formatted data and/or instructions by carrier waves include, but are not limited to, transfers (uploads, downloads, e-mail, etc.) over the Internet and/or other computer networks via one or more data transfer protocols (e.g., HTTP, FTP, SMTP, etc.).

Indeed, when received within a computer system via one or more computer-readable media, such data and/or instruction-based expressions of the above described circuits may be processed by a processing entity (e.g., one or more processors) within the computer system in conjunction with execution of one or more other computer programs including, without limitation, net-list generation programs, place and route programs and the like, to generate a representation or image of a physical manifestation of such circuits. Such representation or image may thereafter be used in device fabrication, for example, by enabling generation of one or more masks that are used to form various components of the circuits in a device fabrication process.

Moreover, the various circuits, circuitry and techniques disclosed herein may be represented via simulations using computer aided design and/or testing tools. The simulation of the circuits, circuitry, layout and routing, and/or techniques implemented thereby, may be implemented by a computer system wherein characteristics and operations of such circuits, circuitry, layout and techniques implemented thereby, are imitated, replicated and/or predicted via a computer system. The present inventions are also directed to such simulations of the inventive circuits, circuitry and/or techniques implemented thereby, and, as such, are intended to fall within the scope of the present inventions. The computer-readable media corresponding to such simulations and/or testing tools are also intended to fall within the scope of the present inventions.

Notably, reference herein to “one embodiment” or “an embodiment” (or the like) means that a particular feature, structure, or characteristic described in connection with the embodiment may be included, employed and/or incorporated in one, some or all of the embodiments of the present inventions. The usages or appearances of the phrase “in one embodiment” or “in another embodiment” (or the like) in the specification are not referring to the same embodiment, nor are separate or alternative embodiments necessarily mutually exclusive of one or more other embodiments, nor limited to a single exclusive embodiment. The same applies to the term “implementation.” The present inventions are neither limited to any single aspect nor embodiment thereof, nor to any combinations and/or permutations of such aspects and/or embodiments. Moreover, each of the aspects of the present inventions, and/or embodiments thereof, may be employed alone or in combination with one or more of the other aspects of the present inventions and/or embodiments thereof. For the sake of brevity, certain permutations and combinations are not discussed and/or illustrated separately herein.

Further, an embodiment or implementation described herein as “exemplary” is not to be construed as ideal, preferred or advantageous, for example, over other embodiments or implementations; rather, it is intended convey or indicate the embodiment or embodiments are example embodiment(s).

Although the present inventions have been described in certain specific aspects, many additional modifications and variations would be apparent to those skilled in the art. It is therefore to be understood that the present inventions may be practiced otherwise than specifically described without departing from the scope and spirit of the present inventions. Thus, embodiments of the present inventions should be considered in all respects as illustrative/exemplary and not restrictive.

The terms “comprises,” “comprising,” “includes,” “including,” “have,” and “having” or any other variation thereof, are intended to cover a non-exclusive inclusion, such that a process, method, circuit, article, or apparatus that comprises a list of parts or elements does not include only those parts or elements but may include other parts or elements not expressly listed or inherent to such process, method, article, or apparatus. Further, use of the terms “connect”, “connected”, “connecting” or “connection” herein should be broadly interpreted to include direct or indirect (e.g., via one or more conductors and/or intermediate devices/elements (active or passive) and/or via inductive or capacitive coupling)) unless intended otherwise (e.g., use of the terms “directly connect” or “directly connected”).

The terms “a” and “an” herein do not denote a limitation of quantity, but rather denote the presence of at least one of the referenced item. Further, the terms “first,” “second,” and the like, herein do not denote any order, quantity, or importance, but rather are used to distinguish one element/circuit/feature from another.

In addition, the term “integrated circuit” means, among other things, any integrated circuit including, for example, a generic or non-specific integrated circuit, processor, controller, state machine, gate array, SoC, PGA and/or FPGA. The term “integrated circuit” also means, for example, a processor, controller, state machine and SoC—including an embedded FPGA.

Further, the term “circuitry”, means, among other things, a circuit (whether integrated or otherwise), a group of such circuits, one or more processors, one or more state machines, one or more processors implementing software, one or more gate arrays, programmable gate arrays and/or field programmable gate arrays, or a combination of one or more circuits (whether integrated or otherwise), one or more state machines, one or more processors, one or more processors implementing software, one or more gate arrays, programmable gate arrays and/or field programmable gate arrays. The term “data” means, among other things, a current or voltage signal(s) (plural or singular) whether in an analog or a digital form, which may be a single bit (or the like) or multiple bits (or the like).

Notably, the term “MAC circuit” means a multiplier-accumulator circuit of the multiplier-accumulator circuitry of the multiplier-accumulator pipeline. For example, a multiplier-accumulator circuit is described and illustrated in the exemplary embodiment of FIGS. 1A-1C of U.S. patent application Ser. No. 16/545,345, and the text associated therewith. In the claims, the term “MAC circuit” means a multiply-accumulator circuit, for example, like that described and illustrated in the exemplary embodiment of FIGS. 1A-1C, and the text associated therewith, of U.S. patent application Ser. No. 16/545,345. Notably, however, the term “MAC circuit” is not limited to the particular circuit, logical, block, functional and/or physical diagrams, block/data width, data path width, bandwidths, and processes illustrated and/or described in accordance with, for example, the exemplary embodiment of FIGS. 1A-1C of U.S. patent application Ser. No. 16/545,345.

Notably, the limitations of the claims are not written in means-plus-function format or step-plus-function format. It is applicant's intention that none of the limitations be interpreted pursuant to 35 USC § 112, ¶6 or § 112(f), unless such claim limitations expressly use the phrase “means for” or “step for” followed by a statement of function and is void of any specific structure.

Again, there are many inventions described and illustrated herein. While certain embodiments, features, attributes and advantages of the inventions have been described and illustrated, it should be understood that many others, as well as different and/or similar embodiments, features, attributes and advantages of the present inventions, are apparent from the description and illustrations.

What is claimed is:

1. An integrated circuit comprising:
a MAC pipeline including a plurality of multiplier-accumulator circuits connected in series to perform concatenated multiply and accumulate operations, wherein each multiplier-accumulator circuit of the plurality of multiplier-accumulator circuits of the MAC pipeline includes:
a multiplier circuit array, including a plurality of multiplier circuits, to: (i) receive first data and filter weight data, (ii) multiply first data and filter weight data and generate product data and (iii) output the product data,
wherein the plurality of multiplier circuits includes:
a first multiplier circuit, having a multiply core, to multiply a first portion of the first data and a first portion of the filter weight data to generate a first field, and
a second multiplier circuit, having a multiply core, to multiply a second portion of the first data and a second portion of the filter weight data to generate a second field, wherein the product data includes data which is representative of the first field and the second field; and
an accumulator circuit, coupled to the multiplier circuit array of the associated multiplier-accumulator circuit, to (i) receive the product data from the associated multiplier circuit array, and (ii) add the product data and second data to generate sum data; and
wherein the multiply core of the first multiplier circuit and the multiply core of the second multiplier circuit are separate and different multiply cores.

2. The integrated circuit of claim 1 wherein:
the multiply core of first multiplier circuit is a floating point type; and
the multiply core of the second multiplier circuit is a fixed point type.

3. The integrated circuit of claim 2 wherein:
the fixed point type multiply core of the second multiplier circuit is an integer type.

4. The integrated circuit of claim 3 wherein:
the multiply core of the second multiplier is integrated into the first multiplier circuit.

5. The integrated circuit of claim 2 wherein:
the first field of the product data is an exponent field, and
the second field of the product data is a fraction field.

6. The integrated circuit of claim 5 wherein each multiplier circuit array of each multiplier-accumulator circuit of the MAC pipeline further includes:
an interconnection bus disposed between and connecting the first multiplier circuit and the second multiplier circuit.

7. The integrated circuit of claim 6 wherein:
the interconnection bus is a point-to-point bus.

8. The integrated circuit of claim 6 wherein the first multiplier circuit of each multiplier circuit array of each multiplier-accumulator circuit of the MAC pipeline further includes:
rounding circuitry to receive the second field from the second multiplier circuit and output a rounded second field wherein the rounded second field is the second field of the product data.

9. An integrated circuit comprising:
a MAC pipeline including a plurality of multiplier-accumulator circuits connected in series to perform concatenated multiply and accumulate operations, wherein each multiplier-accumulator circuit of the plurality of multiplier-accumulator circuits of the MAC pipeline includes:
a multiplier circuit array, including a plurality of multiplier circuits, to: (i) receive first data and filter weight data, (ii) multiply first data and filter weight data and generate product data and (iii) output the product data,
wherein the plurality of multiplier circuits includes:
a first multiplier circuit, having a multiply core, to multiply a first portion of the first data and a first portion of the filter weight data to generate a first field,
a second multiplier circuit, having a multiply core, wherein the second multiplier circuit is configurable to multiply a second portion of the first data and a second portion of the filter weight data to generate a second field,
a third multiplier circuit, having a multiply core, wherein the third multiplier circuit is configurable to multiply a second portion of the first data and a second portion of the filter weight data to generate a second field, wherein the product data includes data which is representative of the first field and the second field; and
an accumulator circuit, coupled to the multiplier circuit array of the associated multiplier-accumulator circuit, to (i) receive the product data from the associated multiplier circuit array, and (ii) add the product data and second data to generate sum data; and
wherein the multiply core of the first multiplier circuit, the second multiplier circuit and the third multiplier circuit are separate and different multiply cores.

10. The integrated circuit of claim 9 wherein:
the multiply core of first multiplier circuit is a floating point type;
the multiply core of the second multiplier circuit is a fixed point type; and
the multiply core of the third multiplier circuit is a fixed point type.

11. The integrated circuit of claim 9 wherein:
the second multiplier circuit is an A×A integer type multiply core, and
the third multiplier circuit is a B×B integer type multiply core, wherein A and B are positive integers representing the number of bits in each operand, and A is greater than B.

12. The integrated circuit of claim 11 wherein:
the multiply core of the first multiplier is a C×C floating point type multiply core wherein C is a positive integer representing the number of bits in each operand, and C is greater than A or B.

13. The integrated circuit of claim 10 wherein:
the first field is an exponent field of the product data, and
the second field is a fraction field of the product data.

14. The integrated circuit of claim 10 wherein each multiplier circuit array of each multiplier-accumulator circuit of the MAC pipeline further includes:
an interconnection bus disposed between and connecting (i) the first multiplier circuit and the second multiplier circuit and (ii) the first multiplier circuit and the third multiplier circuit.

15. The integrated circuit of claim 14 wherein each multiplier circuit array of each multiplier-accumulator circuit of the MAC pipeline further includes:
an selection circuitry connected to and/or in the interconnection bus to responsively connect one of (i) the first multiplier circuit and the second multiplier circuit, via the interconnection bus, and (ii) the first multiplier circuit and the third multiplier circuit, via the interconnection bus.

16. The integrated circuit of claim 9 wherein each multiplier circuit array of each multiplier-accumulator circuit of the MAC pipeline further includes:
disable circuitry, connected to the second multiplier circuit and the third multiplier circuit, to responsively disable one of the second multiplier circuit and the third multiplier circuit in operation of the multiplier circuit array.

17. The integrated circuit of claim 9 wherein the first multiplier circuit of each multiplier circuit array of each multiplier-accumulator circuit of the MAC pipeline further includes:
rounding circuitry to (i) receive the second field from one of the second multiplier circuit or the third multiplier circuit, and (ii) output a rounded second field wherein the rounded second field is the second field of the product data.

18. An integrated circuit comprising:
a MAC pipeline including a plurality of multiplier-accumulator circuits connected in series to perform concatenated multiply and accumulate operations, wherein each multiplier-accumulator circuit of the plurality of multiplier-accumulator circuits of the MAC pipeline includes:
a multiplier circuit array, including a plurality of multiplier circuits, to: (i) receive first data and filter weight data, (ii) multiply first data and filter weight data and generate product data and (iii) output the product data,
wherein the plurality of multiplier circuits includes:
a floating point type multiplier circuit, having an A×A multiply core, to multiply an exponent field of the first data and an exponent field of the filter weight data to generate an exponent field, and
an integer type multiplier circuit, having a B×B multiply core, to multiply a fraction field of the first data and a fraction field of the filter weight data to generate a fraction field, wherein the product data includes data which is representative of the exponent field and the fraction field; and
an accumulator circuit, coupled to the multiplier circuit array of the associated multiplier-accumulator circuit, to (i) receive the product data from the associated multiplier circuit array and (ii) add the product data and second data to generate sum data; and
wherein A and B are positive integers representing the number of bits in each operand.

19. The integrated circuit of claim 18 wherein:
A is greater than B.

20. The integrated circuit of claim 18 wherein:
B is greater than A.

21. The integrated circuit of claim 18 wherein each multiplier circuit array of each multiplier-accumulator circuit of the MAC pipeline further includes:
an interconnection bus disposed between and connecting the first multiplier circuit and the second multiplier circuit, wherein the interconnection bus is a point-to-point bus.

22. The integrated circuit of claim 18 wherein the first multiplier circuit of each multiplier circuit array of each multiplier-accumulator circuit of the MAC pipeline further includes:
rounding circuitry to receive the second field from the integer type multiplier circuit and output a rounded second field wherein the rounded second field is the second field of the product data.
